(19) United States
(12) Patent Application Publication
(10) Pub. No.: US 2004/0267637 A1
(43) Pub. Date: Dec. 30, 2004

(54) Order-receiving system and order-receiving method

(75) Inventors: Toshiya Sato, Tokyo (JP); Moeko Hagiwara, Ichikawa-shi (JP); Shinji Murata, Tokyo (JP); Tomoaki Tamura, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA PHOTO IMAGING, INC.

(21) Appl. No.: 10/826,323

(22) Filed: Apr. 19, 2004

(30) Foreign Application Priority Data
Apr. 23, 2003 (JP) JP2003-118375
Apr. 23, 2003 (JP) JP2003-118394
Apr. 24, 2003 (JP) JP2003-119376
Apr. 24, 2003 (JP) JP2003-119378

(51) Int. Cl. G06F 17/60

(52) U.S. Cl. 705/27

(57) ABSTRACT

An order-receiving system comprising: a network; a user terminal which is connected to the network and is for inputting design determining information, uploading images for use in a design, and ordering the design; an order manager terminal which is connected to the network, and is for receiving the design orders, ordering design creation work based on the design orders and for doing order management via the order server, and which includes a design distribution screen for distributing images for use in the design, or design order work to workers; and a worker terminal which is connected to the network and is for creating the design based on the order placed for the design creation work, and e-mails are issued, and by including order progress information in the title of the issued e-mails, the e-mail title can be extracted or sorted by order progress information.

### BACKGROUND OF INVENTION

This invention relates to an order receiving system and order receiving method for providing the user (customer) with a service for creating, for example, designs for postcards such as those including photo images, via a network such as the internet.

In recent years, many users (customers) have been sending wedding greetings, new-year greetings etc. by postcards with photo images. Also, business cards etc. that have photo images are becoming popular. Network business has been proposed, by which the order for creating these postcards or business cards with photo images is done via the internet (For example, see patent document No. 1).

In this case, when the postcard is being ordered, the user (customer) may for example select a set layout for the postcard design, or may decide on an individually selected layout for the position of the photo image or the text information. The text information to be input may include user address, name, and the greetings. A single photo image may be used, or a number of photo images may be superimposed, and these photo images are sent and instructions given for design creation. Corrections such as removal of unnecessary background and elimination of red eyes can also be done.

At output centers that provide image printing services based on design orders from these users (customers), orders for creating the designs are placed with the workers who do designing and the like, and when design creation is complete, the design is checked with the design order received from the user (customer). This is then printed out and sent to the user (customer).

[Patent Document 1]

Japanese Application Patent Laid-Open Publication No. 2002-149793, (Pages 1-8, FIGS. 1-10)

It is to be noted that, at output centers and the like that provide image printing services, because the condition of the photo image delivered by the user (customer) for use in design creation cannot be previewed, sometimes suitable determinations cannot be made with regard to the man-hour required for completion of the design creation work etc., and at times the user (customer) cannot be provided with a correct cost estimate.

In addition, at the output centers and the like that provide image printing services, there are times when confirmation must be done to ensure that the design created by the designer matches the design ordered by the user (customer).

Also in some cases, the photo image delivered by the user (customer) for use in the design may have too few pixels, and thus the condition of the complete design may be poor, or there may be problems with respect to rights to the portrait, or with respect to public decency issues and the like.

Also, the design orders are placed by distributing them among workers such as designers and the like, but there are cases were the work becomes backed up at the worker-side, so there is a large stock of orders. There are also cases where a worker does not have the design creation skills required for a design order, and thus placing the orders by distributing the design orders among the workers was a troublesome process.

Further, after the orders are placed by distributing the design orders among the designers, and the design creation is complete, the design that is created is checked to determine if it is the same as the order, and there are times when instructions are given to revise the design creation. Also, at the worker side for example, when work backs up and there is a large stock of orders, sometimes demands are made for the orders to be delivered.

E-mail is used for this type of correspondence, but as shown in FIG. 31 for example, there are many types of e-mail titles all mixed together on the e-mail manager screen that is displayed on the terminal at the output center, and it is difficult to determine the progress status of the design creation or the content of data being sent from looking at the e-mail titles. As a result, it becomes impossible to manage the design creation work.

### SUMMARY OF THE INVENTION

This invention was conceived in view of the above-described problems, and preferable embodiments provide order receiving systems and order receiving methods which make it possible to display and check the image delivered by the user for use in the design, and in which the distribution of the design orders among the workers is simplified, and design order management can be easily done based on the e-mail title.

In order to solve the above-described problems, the preferable embodiments of this invention are the configurations and methods described in the following.

(1) An order-receiving system comprising: a network; a user terminal which is connected to the network and is for inputting design determining information, uploading images for use in a design and ordering the design; an order manager terminal which is connected to the network, and is for receiving the design orders, placing orders for the design creation work based on the design order and managing the received orders via an order server, and on which the images for use in the design are displayable; and a worker terminal which is connected to the network and is for creating designs based on the orders placed for the design creation work.

(2) An order-receiving system described in (1), wherein at the order manager terminal, the images for use in the design can be displayed as a list of thumbnail images.

(3) An order-receiving system described in (1), wherein at the order manager terminal, the images for use in the design can be displayed as original images.

(4) An order-receiving system described in any one of (1) to (3), wherein at the order manager terminal, the images for use in the design and the design determining information can be displayed simultaneously.

(5) An order-receiving system described in any one of (1) to (4), wherein at the order manager terminal, the images for use in the design can be inspected.

(6) An order-receiving system described in any one of (1) to (5), wherein at the order manager terminal, identification marks can be attached to the images for use in the design.

(7) An order-receiving system described in any one of (1) to (6), wherein at the order manager terminal, the created design can be revised.

(8) An order-receiving method comprising: inputting the design determining information, uploading images for use in the design and ordering the design from a user terminal; receiving the design orders, placing orders for the design creation work based on the design orders, and managing the received orders via an order server at an order manager terminal at which the images for use in the design can be displayed; and creating the design based on the order placed for the design creation work at a worker terminal.

(9) An order-receiving method described in (8), wherein the images for use in the design can be displayed as a list of thumbnail images.

(10) An order-receiving method described in (8), wherein the images for use in the design can be displayed as original images.

(11) An order-receiving method described in any one of (8) to (10), wherein the images for use in design and the design determining information can be displayed simultaneously.

(12) An order-receiving method described in any one of (8) to (11), wherein the images for use in the design can be inspected.

(13) An order-receiving method described in any one of (8) to (12), wherein identification marks can be attached to the images for use in the design.

(14) An order-receiving method described in any one of (8) to (13), wherein the created design is revised.

(15) An order-receiving system comprising: a network; an order manager terminal which is connected to the network, and is for receiving design orders, placing orders for the design creation work based on the design order and managing the received orders via an order server, and which has a design distribution screen for distributing the design orders among the workers; and a worker terminal which is connected to the network and is for creating the design based on the order placed for the design creation work.

(16) An order-receiving system described in (15), wherein the design distribution screen displays the work status of each of the workers carrying out the design creation work.

(17) An order-receiving system described in (15) or (16), wherein the design distribution screen displays the skills of each of the workers carrying out the design creation work.

(18) An order-receiving system described in one of (15) to (17), wherein the skill is determined based on at least one of: correction frequency for created design; average turnaround time for design completion; frequency of late design delivery; design evaluation; and content of user questionnaire.

(19) An order-receiving system described in one of (15) to (18), wherein the user terminal has a user questionnaire screen.

(20) An order-receiving system described in one of (15) to (18), wherein the order manager terminal has a list display screen which displays work status and skill details.

(21) An order-receiving system described in (20), wherein the list display screen displays an alert when correction frequency for created design; average turnover time for design completion; or frequency of late design delivery exceeds a standard.

(22) An order-receiving system described in one of (15) to (21), wherein the order manager terminal distributes the design orders among the workers in accordance with the work status of each of the workers.

(23) An order-receiving system described in one of (15) to (21), wherein the order manager terminal distributes the design orders among the workers in accordance with the skill of each of the workers.

(24) An order-receiving system described in one of (15) to (21), wherein the order manager terminal distributes the design orders among the workers in accordance with the work status and the skill of each of the workers.

(25) An order-receiving system described in one of (15) to (21), wherein the order manager terminal distributes the design orders among the workers in accordance with the type of design order and/or level of difficulty of the design order.

(26) An order-receiving method comprising: inputting design determining information, uploading the images for use in the design and ordering the design from a user terminal; receiving the design orders, placing orders for the design creation work based on the design orders, and managing the received orders via an order server at an order manager terminal at which display of the distribution of design orders among the workers is possible; and creating the design based on the order placed for the design creation work at a worker terminal.

(27) An order-receiving method described in (26), wherein the work status for each of the workers who carry out the design creation work is displayed.

(28) An order-receiving method described in (26) or (27), wherein the skill of each of the workers who carry out the design creation work is displayed.

(29) An order-receiving method described in one of (26) to (28), wherein the skill is determined based on at least one of: correction frequency of created design; average turnaround time for design completion; frequency of late design delivery; design evaluation; and content of user questionnaire.

(30) An order-receiving method described in one of (26) to (29), wherein the user answers a questionnaire at the user questionnaire screen of user terminal.

(31) An order-receiving method described in one of (26) to (29), wherein the descriptions of work status and skill are displayed on the list display screen of the order manager terminal.

(32) An order-receiving method described in (31), wherein an alert is displayed at the list display screen when correction frequency of created design; average turnaround time for design completion; or frequency of late design delivery exceeds a standard.

(33) An order-receiving method described in one of (26) to (32), wherein the design orders are distributed among the workers in accordance with the work status of each of the workers.

(34) An order-receiving method described in one of (26) to (32), wherein the design orders are distributed among the workers in accordance with the skill of each of the workers.

(35) An order-receiving method described in one of (26) to (32), wherein the design orders are distributed among the workers in accordance with the work status and the skill of each of the workers.

(36) An order-receiving method described in one of (26) to (32), wherein the design orders are distributed among the workers in accordance with the type of design order and/or level of difficulty of the design order.

(37) An order-receiving system comprising: a network; a user terminal which is connected to the network and is for inputting design determining information, uploading the images for use in the design and ordering the design; an order manager terminal which is connected to the network, and is for receiving design orders, placing orders for the design creation work based on the design order and managing the received orders via an order server; and a worker terminal which is connected to the network and is for creating the design based on the order placed for the design creation work, wherein e-mails are issued between the user terminal, the order manager terminal and the worker terminal via the order server, and the title of the e-mails issued include at least progress management information and an order number.

(38) An order receiving system described in (37), wherein the e-mail title includes user name and work completion time, in addition to progress management information and order number.

(39) An order receiving system described in (38), wherein the work completion time is generated by the clock function of the order server.

(40) An order receiving system described in one of (37) to (39), wherein at the e-mail manager screen of the order manager terminal, the e-mail title is displayed with the progress management information at the beginning.

(41) An order receiving system described in one of (37) to (39), wherein at the e-mail manager screen of the worker terminal, the e-mail title is displayed with the order number at the beginning.

(42) An order receiving system described in one of (37) to (39), wherein at the e-mail manager screen of the user terminal, the e-mail title is displayed with the progress management information at the beginning.

(43) An order receiving system described in one of (37) to (42), wherein, when the e-mail is issued, if the destination is the worker terminal, the e-mail is sent with the order number at the beginning of the e-mail title.

(44) An order receiving system described in one of (37) to (42), wherein, when the e-mail is issued, if the destination is the order manager terminal, the e-mail is sent with the progress management information at the beginning of the e-mail title.

(45) An order receiving system described in one of (37) to (42), wherein, when the e-mail is issued, if the destination is the user terminal, the e-mail is sent with the progress management information at the beginning of the e-mail title.

(46) An order receiving system described in (37) or (38), wherein honorific terms for addressing are included in e-mail title being sent to the user terminal.

(47) An order receiving system described in one of (37) to (46), wherein the progress management information is a symbol.

(48) An order receiving system described in one of (37) to (47), wherein when a reply to the issued e-mail is received, an alert e-mail is sent to the issuing terminal.

(49) An order receiving system described in one of (37) to (47), wherein when there is a file attached to the reply to the issued e-mail, an alert e-mail is sent to the issuing terminal.

(50) An order-receiving method comprising: inputting design determining information, uploading images for use in design, and ordering the design at a user terminal; receiving design orders, placing orders for the design creation work based on the design order, and managing the received orders via an order server at an order manager terminal; and creating the design based on the order placed for the design creation work at a worker terminal, wherein e-mails are issued between the user terminal, the order manager terminal and the worker terminal via the order server, and the title of the issued e-mails include at least progress management information and order number.

(51) An order receiving method described in (50), wherein the e-mail title includes the user name and the work completion time, in addition to the progress management information and the order number.

(52) An order receiving method described in (50) or (51), wherein the work completion time is generated by the clock function of the order server.

(53) An order receiving method described in one of (50) to (52), wherein at the e-mail manager screen of the order manager terminal, the e-mail title is displayed with the progress management information at the beginning.

(54) An order receiving method described in one of (50) to (52), wherein at the e-mail manager screen of the worker terminal, the e-mail title is displayed with the order number at the beginning.

(55) An order receiving method described in one of (50) to (52), wherein at the e-mail manager screen of the user terminal, the e-mail title is displayed with the progress management information at the beginning.

(56) An order receiving method described in one of (50) to (55), wherein when the e-mail is issued, if the destination is the worker terminal, the e-mail is sent with the order number at the beginning of the e-mail title.

(57) An order receiving method described in one of (50) to (55), wherein when the e-mail is issued, if the destination is the order manager terminal, the e-mail is sent with the progress management information at the beginning of the e-mail title.

(58) An order receiving method described in one of (50) to (55), wherein when the e-mail is issued, if the destination is the user terminal, the e-mail is sent with the progress management information at the beginning of the e-mail title.

(59) An order receiving method described in (50) or (51), wherein honorific address terms are included in e-mail title being sent to the user terminal

(60) An order receiving method described in one of (50) to (59), wherein the progress management information is a symbol.

(61) An order receiving method described in one of (50) to (60), wherein when a reply to the issued e-mail is received, an alert e-mail is sent to the issuing terminal.

(62) An order receiving method described in one of (50) to (60), wherein when there is file attached to the reply to the issued e-mail, an alert e-mail is sent to the issuing terminal.

(63) An order-receiving system comprising: a network; a user terminal which is connected to the network and is for inputting design determining information, uploading images for use in a design and ordering the design; an order manager terminal which is connected to the network, and is for receiving the design orders, placing orders for the design creation work based on the design order, and managing the received orders via an order server and a worker terminal which is connected to the network and is for creating the design based on the order placed for the design creation work, wherein e-mails are issued between the user terminal, the order manager terminal and the worker terminal via the order server, and order progress information is included in the title of the issued e-mails and the e-mail titles are extracted by the order progress information.

(64) An order receiving system described in (63), wherein the order progress information includes the progress management information, the order number and the user name.

(65) An order-receiving system described in (63) or (64), wherein by clicking the extracted e-mail, the screen that corresponds to the e-mail title is displayed.

(66) An order-receiving system comprising: a network; a user terminal which is connected to the network and is for inputting design determining information, uploading images for use in a design and ordering the design; an order manager terminal which is connected to the network, and is for receiving the design orders, and placing orders for the design creation work based on the design order and managing the received orders via an order server; a worker terminal which is connected to the network and is for creating the design based on the order placed for the design creation work, wherein e-mails are issued between the user terminal, the order manager terminal and the worker terminal via the order server, and the e-mail title of the issued e-mails includes the order progress information, and the e-mail title is sorted by the order progress information.

(67) An order-receiving system described in (66), wherein the order progress information includes the progress management information, the order number and the user name.

(68) An order-receiving system described in (66) or (67), wherein by clicking the sorted e-mail, the screen that corresponds to the e-mail title is displayed.

(69) An order-receiving method comprising: inputting design determining information; uploading images for use in a design and ordering the design at a user terminal; receiving the design orders, placing orders for the design creation work based on the design order, and managing the received orders via an order server at an order manager terminal; and creating the design based on the order placed for the design creation work at a worker terminal; wherein e-mails are issued between the user terminal, the order manager terminal and the worker terminal via the order server, and the title of the e-mails issued include order progress information, and the e-mail title is extracted by order progress information.

(70) An order-receiving method described in (69), wherein the order progress information includes the progress management information, the order number and the user name.

(71) An order-receiving method described in (69) or (70), wherein by clicking the extracted e-mail, the screen that corresponds to the e-mail title is displayed.

(72) An order-receiving method comprising: inputting design determining information; uploading images for use in a design and ordering the design at a user terminal; receiving the design orders, placing orders for the design creation work based on the design order, and managing the received orders via an order server at the order manager terminal; and creating the design based on the order placed for the design creation work at a worker terminal; wherein e-mails are issued between the user terminal, the order manager terminal and the worker terminal via the order server, and the title of the e-mails issued include the order progress information, and the e-mail titles are sorted by order progress information.

(73) An order-receiving method described in (72), wherein the order progress information includes the progress management information, the order number and the user name.

(74) An order-receiving method described in (72) or (73), wherein by clicking the sorted e-mail, the screen that corresponds to the e-mail title is displayed.

### BRIEF DESCRIPTION OF THE DRAWINGS

FIG. 1 shows the order-receiving system.

FIG. 2 shows the flow chart for executing the order receiving method.

FIG. 3 shows the sending and receiving of information between the user terminal, the order manager terminal, the worker terminal, and the order server.

FIG. 4 shows the design selection screen of the user terminal.

FIG. 5 shows the order information input screen of the user terminal.

FIG. 6 shows the design determining screen of the user terminal.

FIG. 7 shows the upload screen of the user terminal.

FIG. 8 shows the design estimate and confirmation screens of the user terminal.

FIG. 9 shows the order management menu screen of the order manager terminal.

FIG. 10 shows the design distribution screen of the order manager terminal.

FIG. 11 shows the order details information screen of the order manager terminal.

FIG. 12 shows the order details information screen of the order manager terminal.

FIG. 13 shows the skill evaluation screen.

FIG. 14 shows the order management screen of the order manager terminal.

FIG. 15 shows inspection at the order manager terminal of the condition of the photo images for use in the design.

FIG. 16 shows the inspection screen of the order manager terminal for the photo images for use in the design.

FIG. 17 shows the addition of identification marks to the images for use in the design.

FIG. 18 shows the design print order instruction screen at the user terminal.

FIG. 19 shows the design print order details screen at the user terminal.

FIG. 20 shows e-mail type and issue-timing.

FIG. 21 shows e-mail issuing screens and e-mail manager screens for the user terminal, order manager terminal and the worker terminal.

FIG. 22 shows the e-mail manager screen of the order manager terminal.

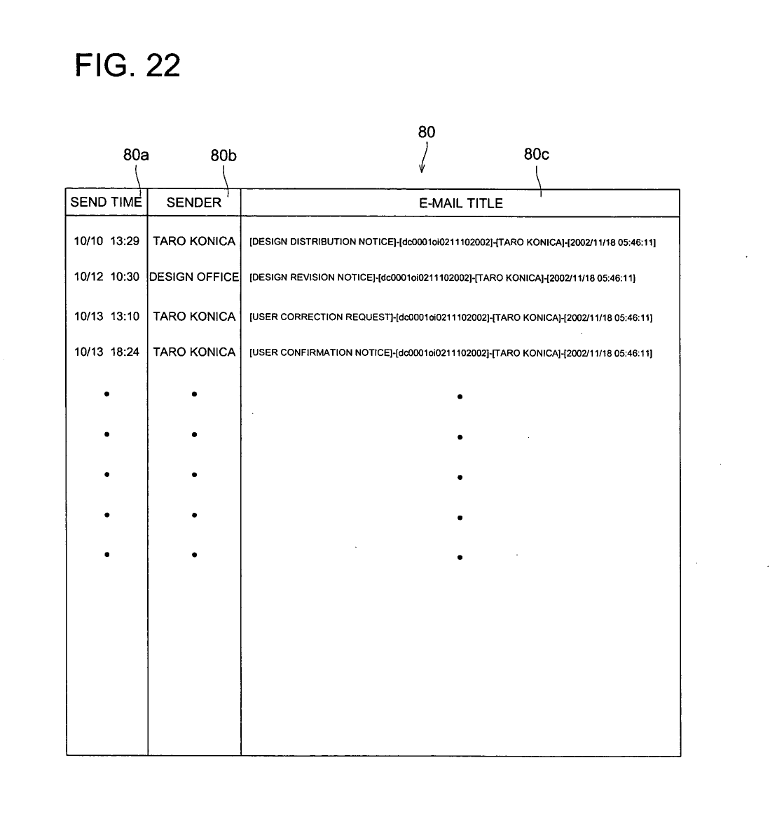

FIG. 23 shows the e-mail manager screen of the worker manager terminal.

FIG. 24 shows the e-mail manager screen of the user terminal.

FIG. 25 shows the design management software menu screen.

FIG. 26 shows the extraction screen.

FIG. 27 shows the extraction confirmation screen.

FIG. 28 shows the sort screen.

FIG. 29 shows the sort confirmation screen.

FIG. 30 shows the correction comment screen.

FIG. 31 shows the e-mail manager screen if the order manager terminal of the prior art.

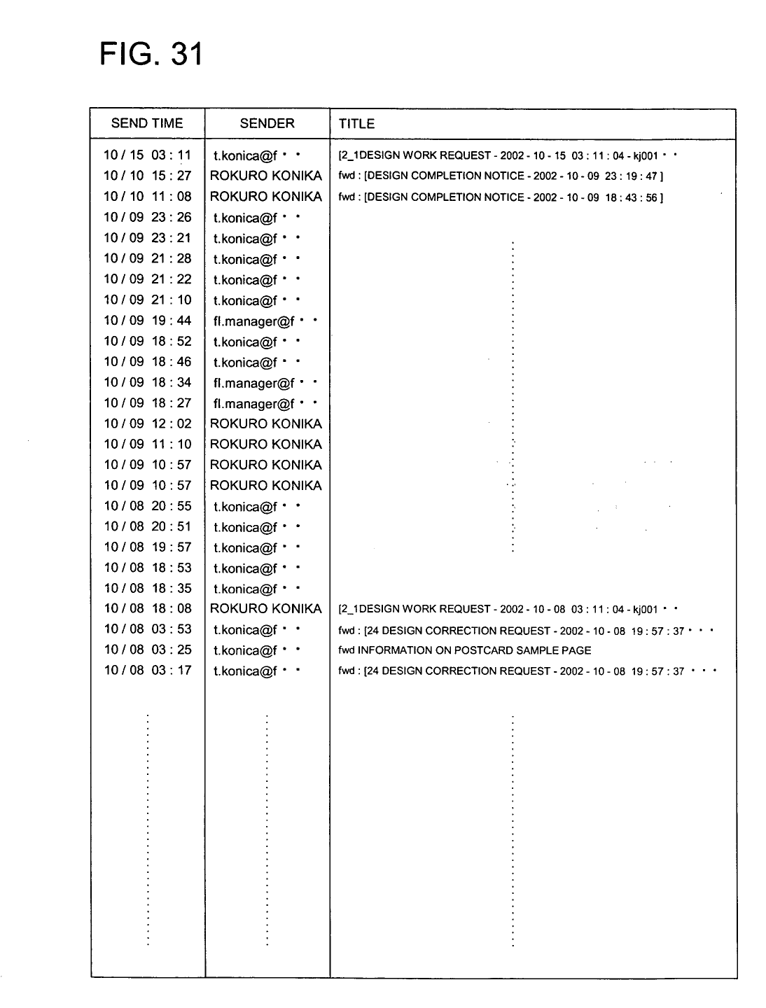

### DETAILED DESCRIPTION OF THE PREFERRED EMBODIMENT

The following is a description of the embodiments of the order receiving system and order receiving method of this invention based on the drawings. However this invention is not to be limited by these embodiments.

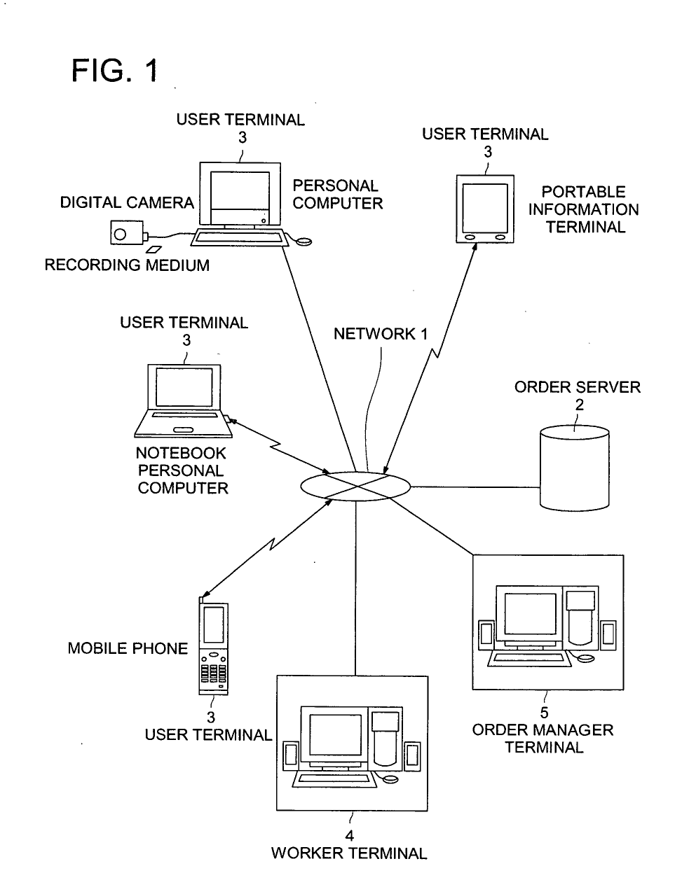

FIG. 1 shows the order receiving system. In FIG. 1, the order server 2, the user terminal 3, the worker terminal 4 and the order manager terminal 5 are connected to the network, and they each can communicate via the network 1.

Network 1 is one where a computer system, terminals and communication devices are connected to each other. The network may be connected by wire such as by dedicated lines, public lines, or may be connected wirelessly by communications satellite, or may be connected by a combination of both. That it to say, the network may include the internet and the like.

The order server 2 receives design orders, and does ordering and management of the design creation order based on the design order via network 1, and provides network image services of listing the images for use in the design, storing images, managing customer information and the like.

The user terminal 3 may be any electronic device terminal that is capable of sending test and image information such as a personal computer, a personal digital assistant (PDA) or a mobile phone. In the case of a personal computer or personal digital assistant (PDA), the user terminal may be connected to a digital camera and a recording medium on which an image has been recorded may be set in the digital camera, so that the image can be uploaded. The image may also be uploaded from a scanner or the like. For a mobile phone that is equipped with a digital camera the image may be obtained by taking pictures with the digital camera, and for a mobile telephone that is not equipped with a digital camera the image may be obtained by being sent from another electronic device.

At the user terminal 3, design determining information is input, the images for use in the design is uploaded, and the design is ordered. Examples of the design determining information include: the design layout number, comments text, and personal information that will be included in the design etc. A number of patterns for the design layout may, for example, be provided, and the ID number may be used to specify the layout. The user (customer) may also be allowed to do their own original layout. Also one or many photo images or illustrations may be used as the images for use in the design.

The order manager terminal 5 receives design orders, orders the design creation work based on the design order and manages the orders via the order server 2, and is capable of displaying the images for use in the design, and has a design distribution screen for distributing the design orders among the workers.

The worker terminals 4 are placed in the shop, and the design creation work is done on the image correction screen based on the design creation work order. The shop refers for example to a lab which is equipped with an image creation device capable of image processing and image correction for the design creation works such as removing unnecessary background from an image or correcting red eye, but is not limited thereto.

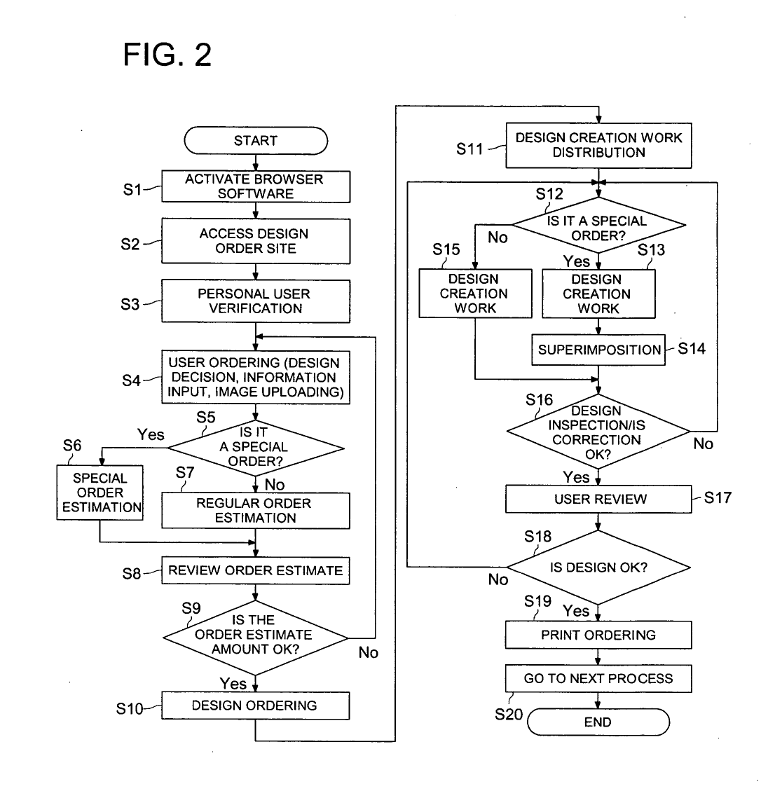

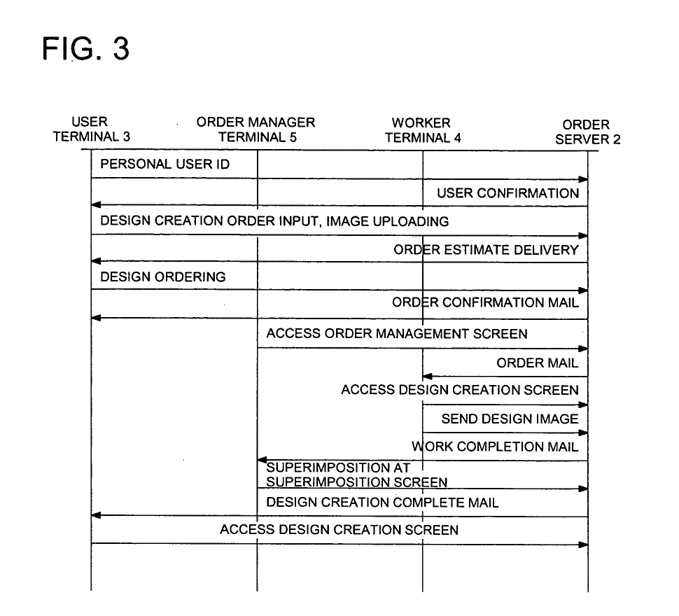

Next, the order receiving method will be described based on FIG. 2 and FIG. 3. FIG. 2 is flow chart for executing the order-receiving method, and FIG. 3 shows the sending and receiving of information between the user terminal, the order manager terminal, the worker terminal, and the order server.

The user activates the browser software of the user terminal 3 (S1), and accesses the design order site (S2). The user ID is input from the user terminal and sent to the order server 2, and the order server 2 checks this with pre-registered user IDs and does personal user verification (S3).

At the user terminal 3, user verification is accepted from the order server 2, the design order information is input, the design determining information is input, and the images for use in the design are uploaded. (S4) A determination is made as to whether the design order is a special order with a layout created by the user (customer) rather than a prescribed layout (S5), and if it is a special order, the order manager does a special order estimate via the order server 2 from the order manager terminal 5 (S6), and for a standard design layout, the regular order estimate is done (S7).

The display screen for confirming the estimate and design order may be viewed at the user terminal 3 (S8), and the estimate amount and then the design order confirmed (S9). If there are no problems, then the design order is made (S10), and order confirmation mail is delivered via the order server 2 from the order manager terminal 5.

At the order manager terminal 5, the design order is accepted and order management is done via the order server 2, the design creation work is distributed, and order placement mail is sent to the worker terminal 4 (S11).

In Step 12, when there is a special order, the order is placed with multiple design workers, and by accessing the worker screen from the worker terminal 4, the worker accepts the design creation work based on the design order and does the design creation work based on the design order on the image correction screen on the worker screen of the worker terminal (S13). When design creation work of the multiple design workers is complete, a work-complete e-mail is sent, and the created design images are sent to the order server 2 from the worker terminal 4, and the images are superimposed at the superimposition screen of the order manager terminal 5 (S14).

In Step 12, in the case where the order is not a special order, it is delivered to a prescribed worker, and by accessing the worker screen from the worker terminal 4, the worker accepts the design creation work based on the design order, and from the worker terminal 4, at the worker screen, the worker does the design creation work based on the design order on the image correction screen (S15). When the design creation work is complete, a work-complete e-mail is sent.

At the order manager terminal 5, the design created by the designer or the like, is inspected to determine if it is the same as the user (customer) design order, and if there is a problem, the process goes to step 12 and the design creation work is carried out again (S16). At this time, design disapproval mail is sent to the worker.

After the inspection and revision is complete, design creation complete e-mail is delivered from the order manager terminal 5 to the user terminal 3 via the order server 2. The design creation complete e-mail is received at the user terminal 3, the design creation screen is accessed, the created design image is inspected (S17) and a determination is made as to whether the design image matches the user order (S18).

If the design does not correspond with the user order, the next step is step 12, and the design creation work is carried out again (S18). In the case where the design corresponds with the order, print ordering is done (S19), the next step is the next process step (S19) and then the end is reached (S20). A user questionnaire is done at the print order screen.

Here the next process refers to (1) receiving the print order from the user (customer) and (2) printing according to the print order and sending it to the user.

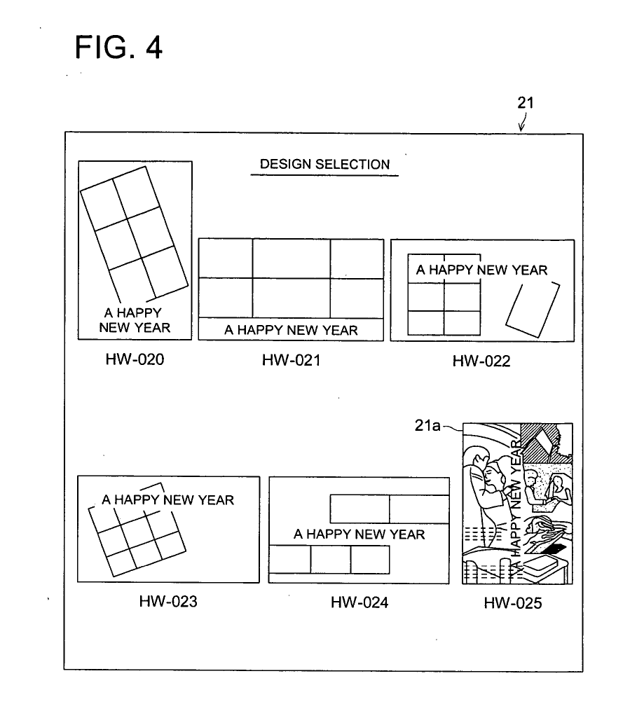

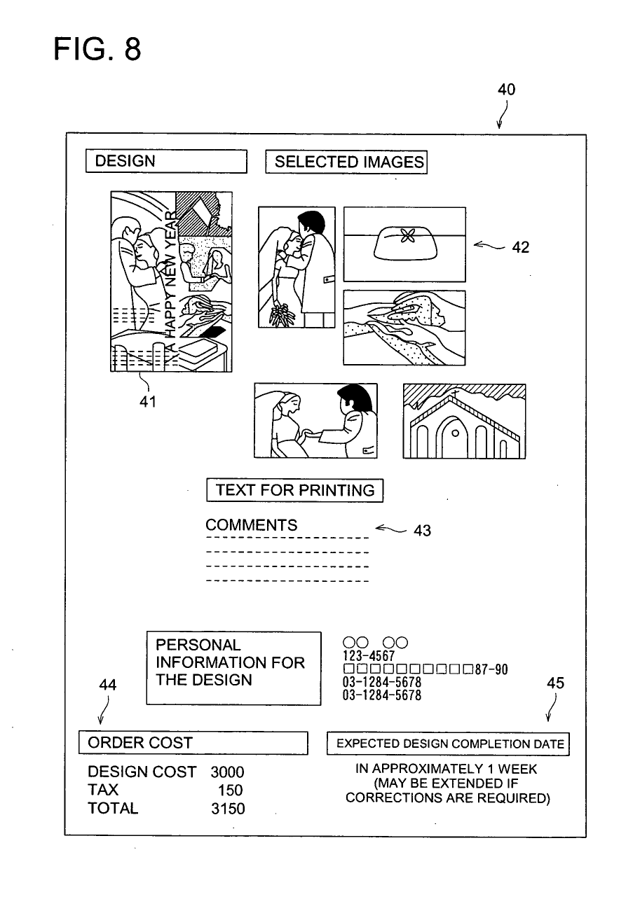

The following is a description of an embodiment of the design order carried out at the user terminal 3 based on FIG. 4 through to FIG. 8.

FIG. 4 shows the design selection screen, and at the design selection screen 21, the desired design screen 21a is clicked to select it from among a plurality of standard design layouts. For example design layout number HW-025 may be clicked.

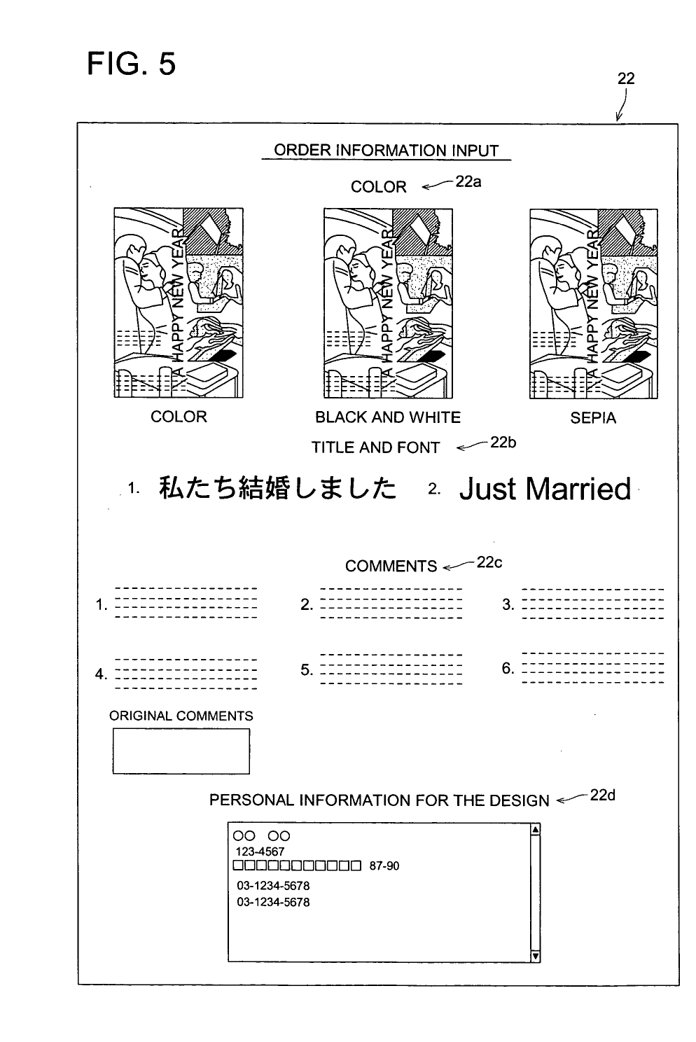

FIG. 5 shows the order information input screen, and at the order information input screen 22, color, title and font, and comment are selected by clicking the color box 22a, the title and font box 22b, the comment box 22c, and the personal information 22d, or the user may input the user's own comment and personal information.

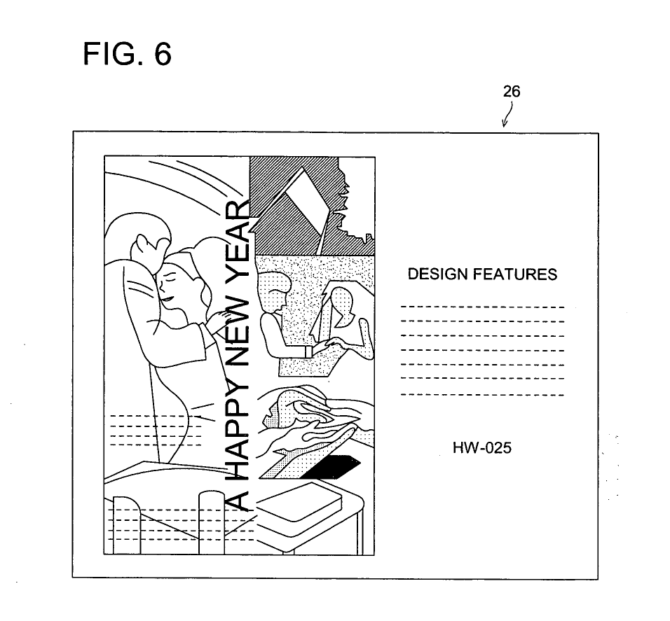

FIG. 6 shows the design determining screen, and at this design determining screen 26, the design is displayed for the design determining information input at the design selection screen of FIG. 4 and the order information input screen of FIG. 5.

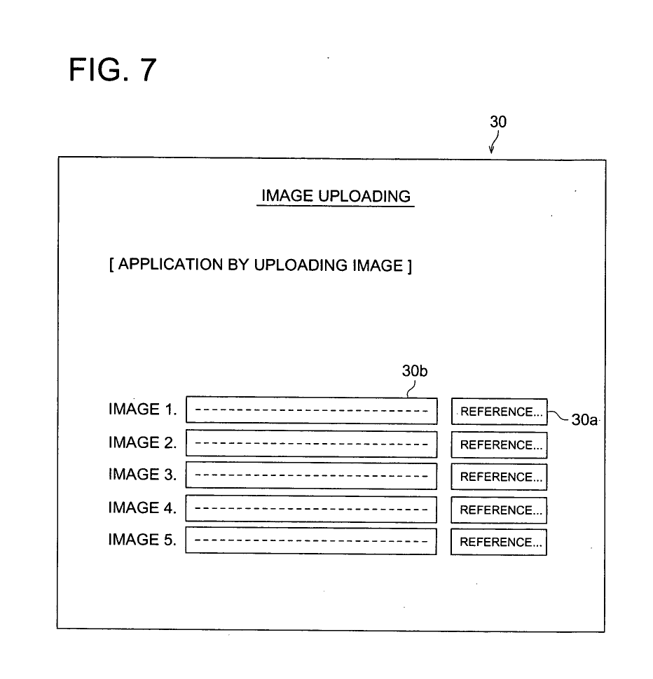

FIG. 7 shows the image upload screen, and at this image upload screen 30, if reference 30a is clicked, the folder 30b which has the images is selected, and the image is selected and uploaded.

FIG. 8 shows the design estimate and confirmation screen, and at this design estimate and confirmation screen 40, the design image 41 to be created, the image 42 for use in the design to be created, the text information 43 for use in the design to be created, the estimate amount 44, and the expected date of design completion 45 are displayed.

The user (customer) views and checks this design estimate and confirmation screen 40, and if the order is as desired and there are no problems, the order is placed.

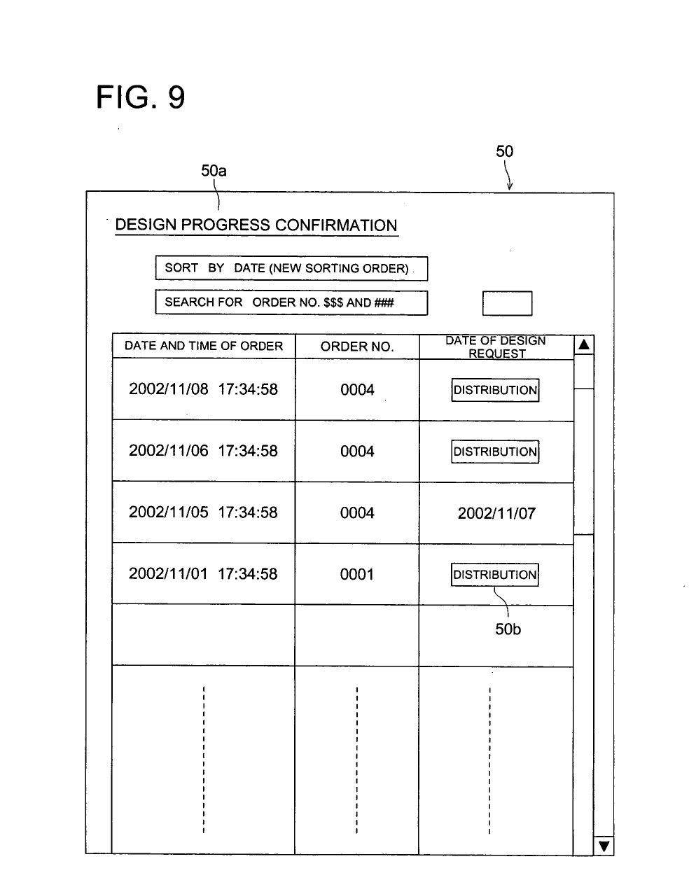

Next an embodiment of the display of the images for use in the design done at the order manager terminal 5 is described based on FIGS. 9 to 17.

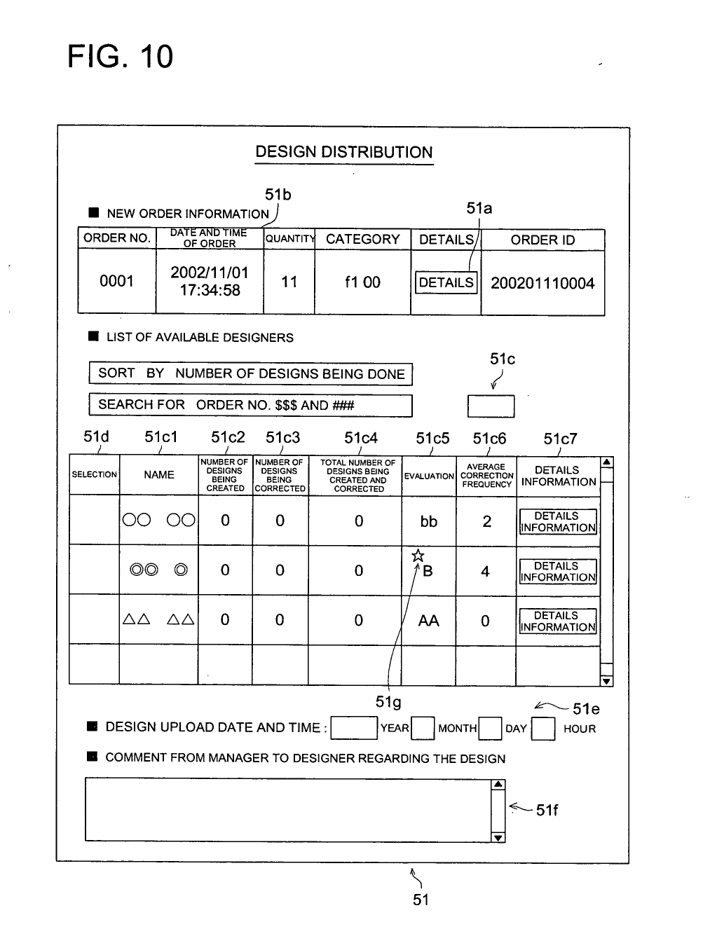

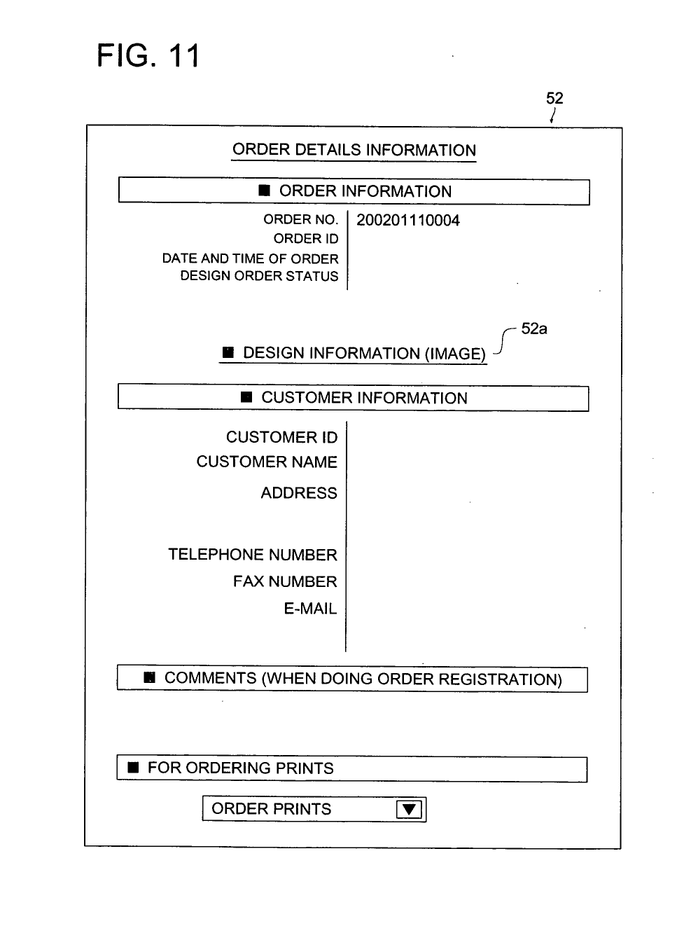

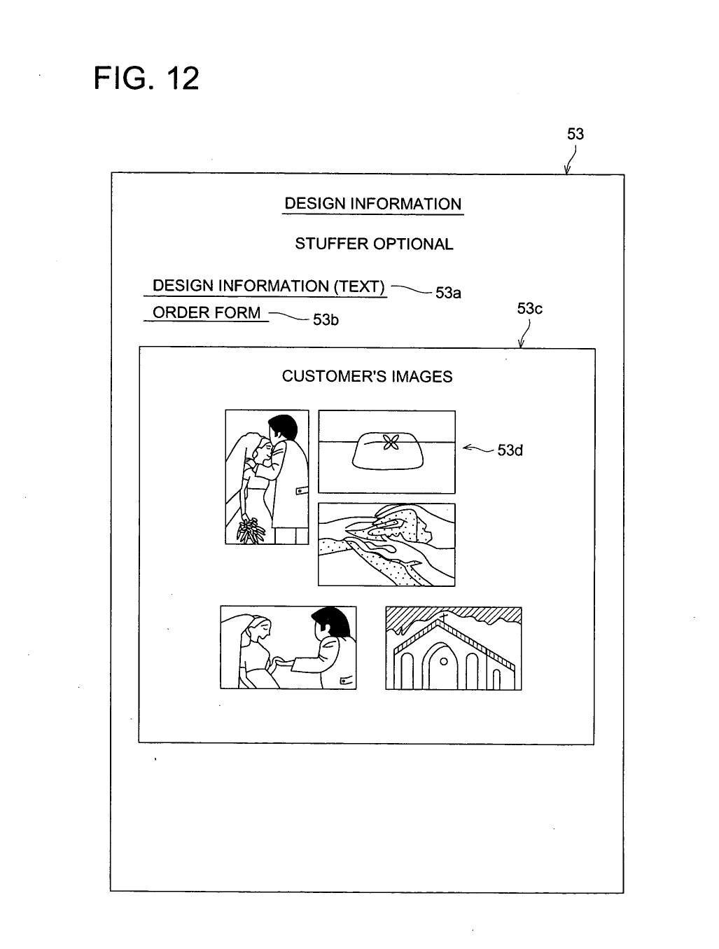

FIG. 9 shows the menu screen for design creation work order placement and order management, and this menu screen 50 has a design progress status confirmation box 50a and distribution box 50b. When the distribution box 50b is clicked, the display switches to the design distribution screen 51 in FIG. 10. When the details box 51a of the design distribution screen 51 is clicked, the display switches to the order details information screen 52 in FIG. 11. When the design information (image) box 52a of the order details information screen 52 is clicked, the design information screen 53 of FIG. 12 is displayed.

The image 53d for use in the design is displayed in the box 53c for the images supplied by the customer. By displaying the image 53d for use in the design in this manner, the design order can be received, and the condition of the image 53d for use in the design can be previewed simultaneously. Thus adequate determination can be made of the number of man-hours etc. required to complete the design creation work, and the user (customer) can be provided with an accurate cost estimate.

In addition, by clicking the image 53d for use in the design and the design information (text) box 53a, and viewing the design order instructions for image processing and the like at the same time, the desires of the user (customer) can be understood.

The design information screen 53 displays the design information (text) box 53a, the order form box 53b, and the customer image box 53c.

The order manager terminal 5 of this embodiment receives the design order, orders the design creation work based on the design order and manages the orders. It also has the design distribution screen 51 shown in FIG. 10 for distributing design orders to the workers.

At the design distribution screen 51, if there is a new design order 51b, a selection 51d is made and a prescribed worker from the worker list 51c is assigned the new design order 51b. The design creation completion and turnaround time 51e and the comments on the design 51f are also shown in the design distribution screen 51.

In the worker list 51c, there are boxes such as worker name 51c1, number of designs being created 51c2, number of designs being corrected 51c3, total number of designs being created and corrected 51c4, evaluation 51c5, average correction frequency 51c6, and details information 51c7, and thus data for each worker is kept.

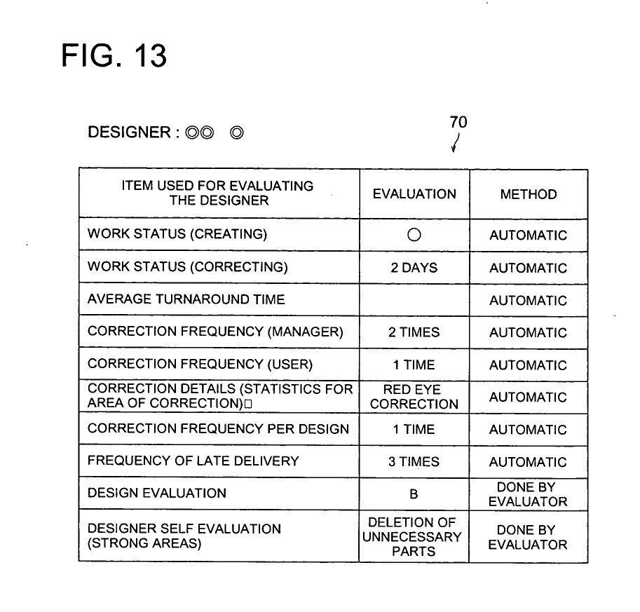

When detailed information 51c7 is clicked, the skill evaluation screen shown in FIG. 13 is displayed. At the skill evaluation screen, automatically set statistical evaluations and objective evaluations are done with respect to the following items.

Evaluations for items which are automatically set can be obtained from software.

| Item used for evaluating the designer | Method |
|---|---|
| Work status (creating) | automatic |
| Work status (correcting) | automatic |
| Average turnaround time | automatic |
| Correction frequency (manager) | automatic |
| Correction frequency (user) | automatic |
| Correction details | automatic |
| (statistics for area of correction) | |
| Correction frequency per design | automatic |
| Frequency of late delivery | automatic |
| Design evaluation | done by evaluator |
| Designer self evaluation | done by evaluator |
| (strong areas) | |

Each of these items is weighted, an overall evaluation is done, and this is displayed in evaluation 51c5 of FIG. 10.

Work load is displayed by average turnaround time and work status, and the designer displaying a high ranking based on this is considered an ideal worker, and thus work distribution becomes simple.

Further, by comparing most recent works using past correction frequency, the tendency for skill development of the designer can be determined, and this can be included in the overall evaluation.

It is also possible to place the order with the worker having optimum designing skill for each design by registering design type, level of difficulty for special orders and regular orders.

Also, when there is an increase trend for the correction frequency, turnaround time or late delivery and the like, an alert mark may be displayed in the evaluation 51c5 box and an alert sent to the order manager and the worker.

The order manager terminal 5 thus includes a design distribution screen 10 for distributing design orders to the workers, and work status for each of the workers doing the design creation work is displayed in number of designs being created 51c2, number of designs being corrected 51c3, total number of designs being created and corrected 51c4 etc. as shown in FIG. 10 and FIG. 13. The order manager can confirm the work status for each of the design workers, and even if there is a large number of design orders, placement of orders with the workers is such that design creation work can be done easily and quickly.

In addition, the design distribution screen 51 displays the skill of each of the workers doing design creation work as evaluation 51c5. By displaying the skill of each of the workers, the order manager can confirm the skill of each of the design workers, and even if there is a large number of design orders, the orders can be easily placed with the workers capable of handling the design order content.

The skill is determined based on at least one of: correction frequency of created design; the average turnaround time for design completion; frequency of late design delivery; design evaluation; and content of user questionnaire. By including the content of the user questionnaire in determining skill, the user opinion can also be considered in confirming skill, and work order can be easily placed with the worker capable of handling the content of the design order.

Because the order manager terminal 5 has the list display screen 51c which displays details of work status and skill, work status and skill can be checked on the same screen, and even if there is a large number of design orders, orders can be easily placed with workers capable of handling the content of the design order.

In addition, if in the list display screen 51c, the correction frequency of created design; average turnaround time for design completion; or frequency of late design delivery exceed a standard, an alert mark 51g can be displayed in evaluation 51c5, and thus an order can easily be placed with an appropriate worker.

Also, at the order manager terminal 5, the order manager may distribute the design order to the workers in accordance with the work status of each of the workers, or it may be done automatically using software. Thus even if the order manager does not know the work status of each of the design workers, the design orders can be placed with an ideal worker.

Also, at the order manager terminal 5, the order manager may distribute the design order to the workers in accordance with the skill of each of the workers, or it may be done automatically using software. Thus even if the order manager does not know the skill of each of the design workers, the design orders can be placed with an ideal worker.

The order manager may also distribute the design order to the workers in accordance with the work status and skill of each of the workers, or it may be done automatically using software, and thus the design orders can be placed with an ideal worker.

The order manager may also distribute the design order to the workers based on the design order type and/or the level of difficulty of the design order, or it may be done automatically using software, and thus all the design orders can be placed with an ideal worker.

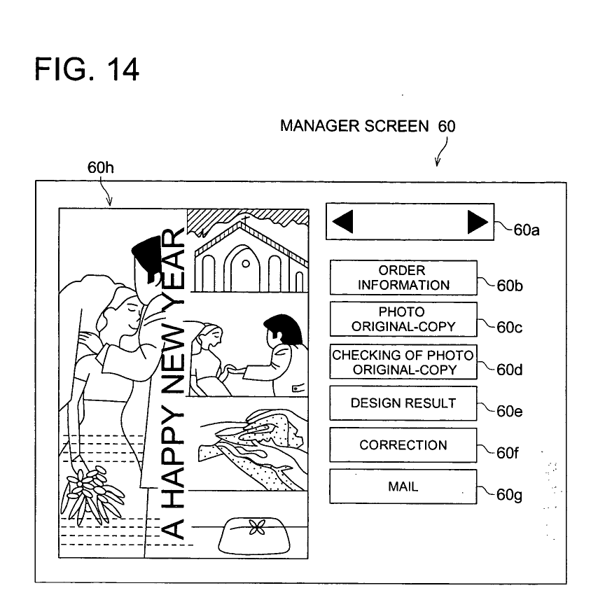

The order manager terminal 5 has an order manager screen shown in FIG. 14, and the order manager screen 60 has an order number toggle button 60a, an order information button 60b, a photo original-copy button 60c; a photo original-copy inspection button 60d; a design result button 60e, a revision button 60f, a mail button 60g, and a display screen 60h.

The order number toggle button 60a toggles the order number by an up toggle or a down toggle. By operating the order information button 60b, information for a design order that is specified by the order number is displayed on the display screen 60h. Also, by operating the photo original-copy button 60c, the images for use in the design are displayed on the display screen 60h.

By operating the photo original-copy inspection button 60d, inspection of the condition of photo image delivered from the user (customer) for use in the design may be done. Inspection may also be done so that problems with respect to rights to the portrait and other problems such as those relating to public decency issues do not occur.

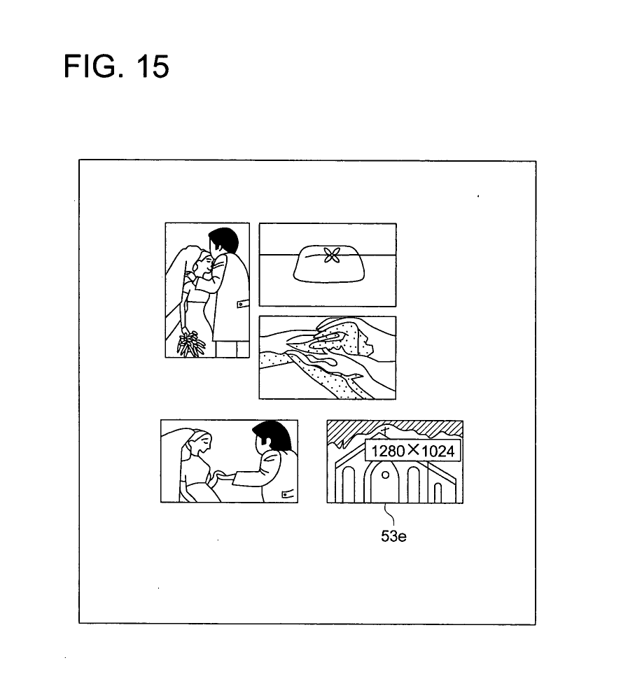

Inspection of the condition of photo images for use in the design is done as shown in FIG. 12, by clicking the image 53d for use in a specified design. As shown in 53e of FIG. 15, the number of pixels in the image that has been clicked is displayed and checks are done to determine whether the image has the appropriate pixel number for the design. The pixel number checking can be done visually by displaying a pixel number criterion or it may be done automatically with checking software, and the results of the determination may also be displayed.

The rights of portrait inspection may be done visually, or may be done using face distinguishing software. The public decency inspection is done by identifying obscene images or discriminatory language.

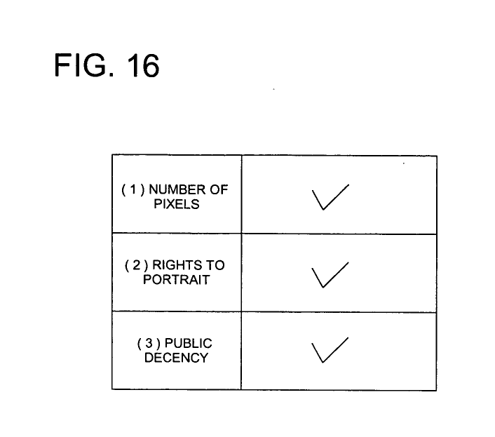

The results of these inspections are displayed on the inspection screen 54 as shown in FIG. 16. It is efficient for the inspections do be done in the order of pixel number, rights to portrait, and then public decency.

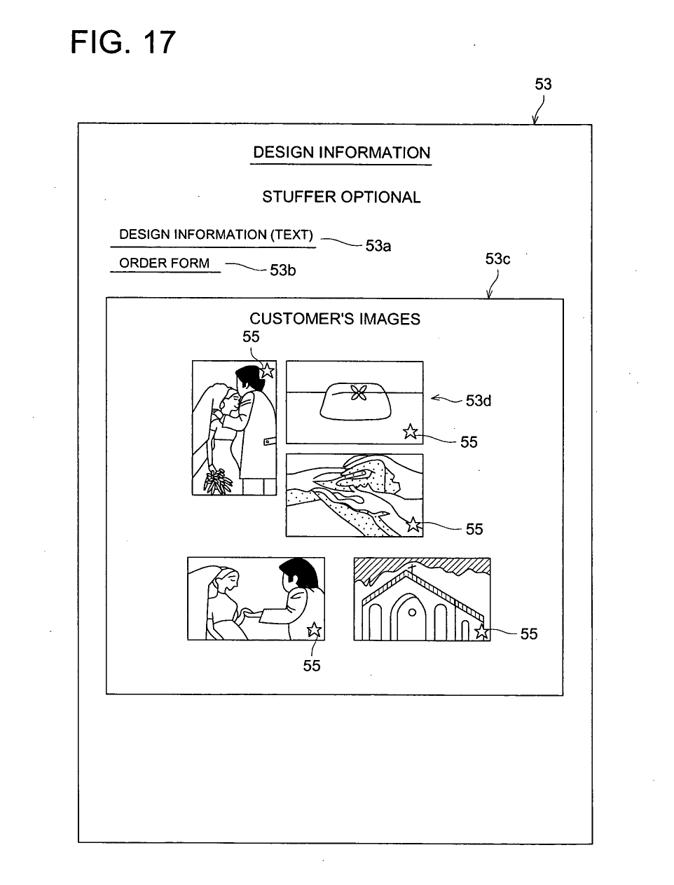

As shown in FIG. 17, at the order manager terminal 5, an identification mark 55 may be attached to the image 53d for use in the design. This identification mark 55 can be put on by placing a unique seal or watermark, for example, at a position where it does not interfere with design creation. By attaching this identification mark 55 to the image 53d for use in the design, design errors can be prevented in subsequent design creation processes by checking for a match with identification mark 55. Matching of identification mark 55 can be done by checking for the presence of identification mark 55, or by checking whether or not the identification mark 55 is the same.

At the order manager terminal 5, the images 53d for use in the design may be displayed as a list of thumbnail images, and by being displayed as a list of thumbnail images, a number of images can be simultaneously viewed and checked.

In addition, the images 53d for use in the design can be displayed as original images, and by being displayed as original images, inspection of the condition of the image and checking to ensure that problems with rights to portrait, public decency etc. can be more accurately done.

The design result button 60e is blank before a design order is placed, and after the design order is placed, the design result button 60e is displayed. By operating this design result button 60e, the created design is displayed on the display screen 60h, and can be checked.

By operating the correction button 60f, the finished design created by the designer or the like that is displayed on the display screen 60h is checked to determine if it matches the design order from the user (customer), and revisions such as text errors and image corrections can be done. By revising the created design, text errors are prevented and this may improve design quality.

By operating the-mail button 60g, the-mail screen is opened, and when a design order is received, mail is sent to a worker such as a designer, and if the design order cannot be placed, mail is sent to the user. Also, by operating the mail button 60g, when the design creation is complete, design creation complete-mail is sent to the user.

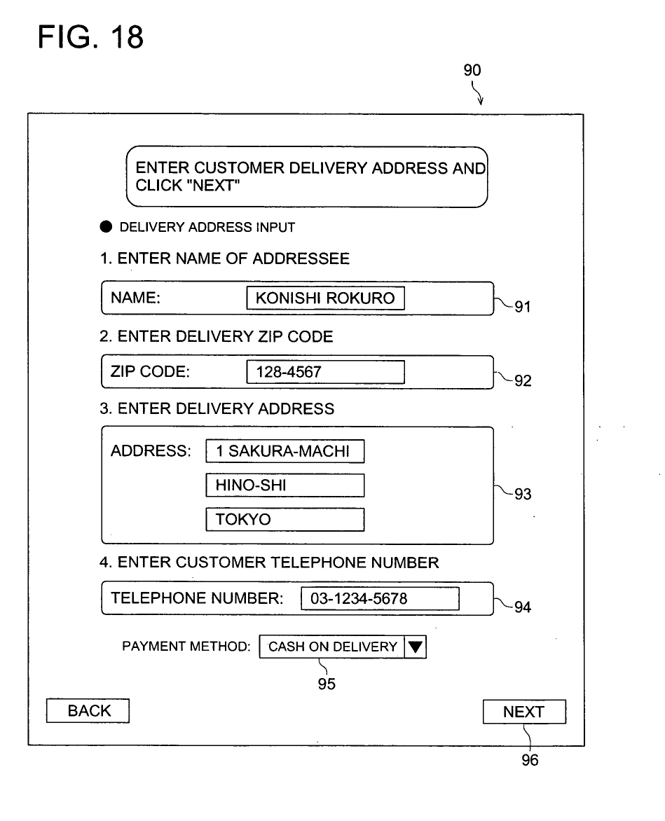

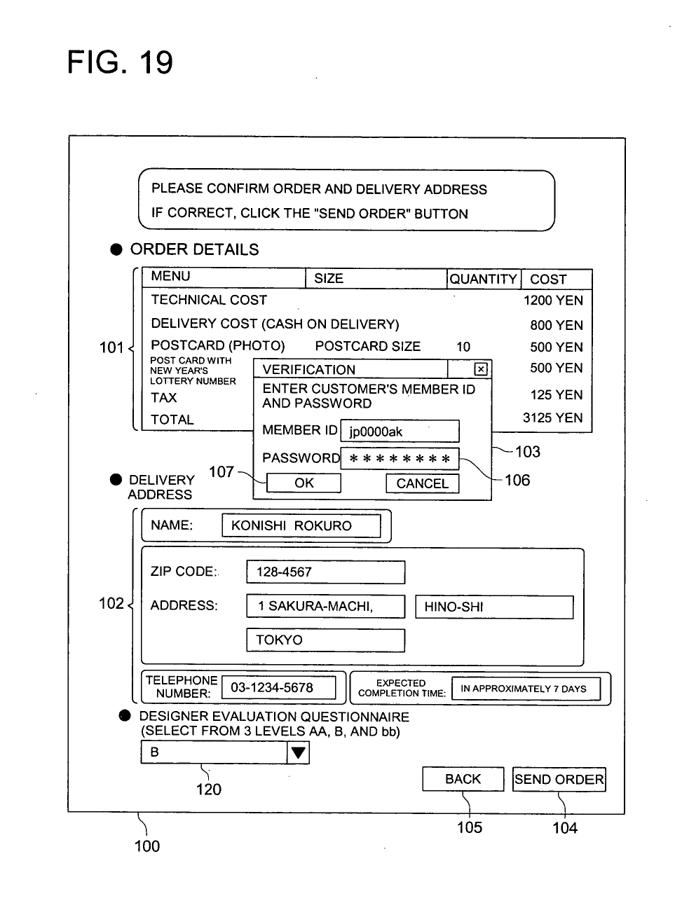

Next, an embodiment of the print ordering which is done at the user terminal 3 will be described based on FIG. 18 and FIG. 19.

Prints of the created design are ordered at the user terminal 3. For example, when the prints are to be delivered by post, delivery address data such as name, zip code, address, telephone number, and payment method are entered in boxes 91-95 at screen 90 of FIG. 18. However, the data in boxes 91-94 may be, for example, downloaded data that is automatically input. In this case, it is possible to change the address information.

By clicking the “next” button 96 on screen 90 of FIG. 18, the order details confirmation screen 100 is displayed as shown in FIG. 19. The user checks the order information of the order details displayed in box 101. After checking the information of the delivery address box details in box 102, if the send order button 104 is clicked, a small screen 103 is displayed for verifying the user, and after entering the registered password in the box 106, if the “OK” button 107 is clicked, the password entered in the box 106 of the small screen 103 is compared with the member password, and if they are the same, order information including the member ID and delivery address is sent to the order server 2 via the network 1. In this case, if an error is discovered in the order information or address information on the screen 100 of FIG. 19, the “return” button may be clicked and the user is returned to the previous screen 90 or the like, and correction can be done.

A questionnaire box 120 is provided on the screen 100, and order manager considers the opinions of the user in checking the skill of worker doing each of the designs, and thus orders can be easily placed with the workers in accordance with the design order content.

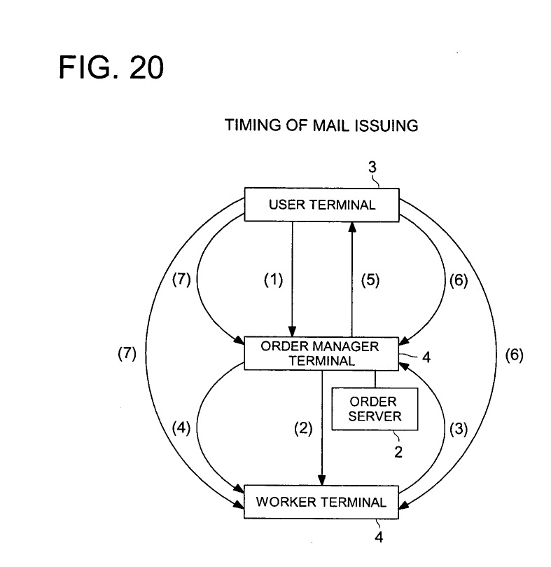

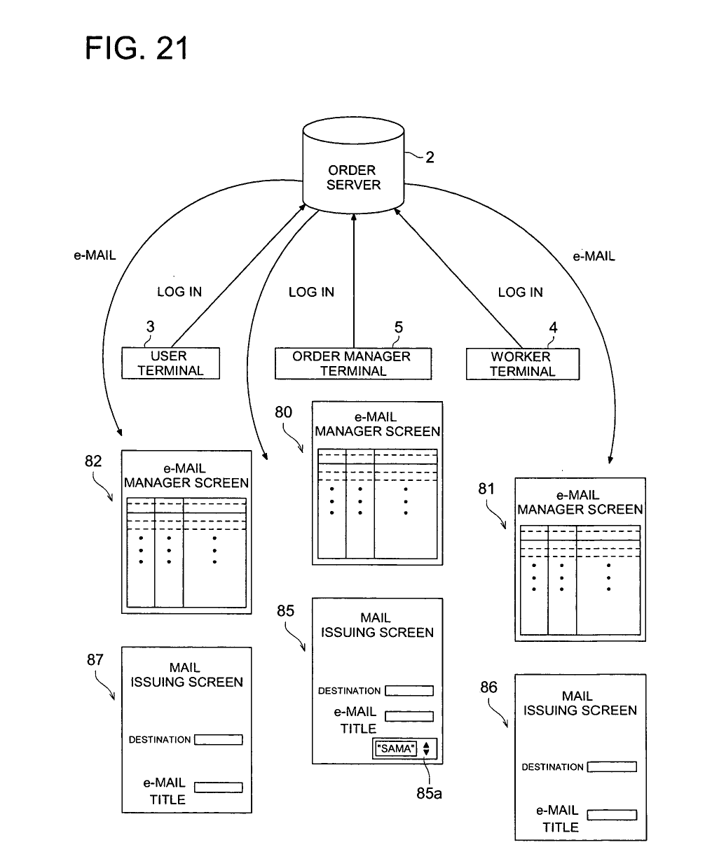

In this manner, design determining information is input at the user terminal 3, the images for use in the design is downloaded, and the design ordered; at the order manager terminal 5, the design order is received, the design creation work is ordered based on the design order and order management is done via the order server 2; and at worker terminal 4, design creation is done based on the order placed for design creation work, and as shown in FIG. 20 and FIG. 21, e-mails are issued between the user terminal 3, the order manager terminal 5, and the worker terminal 4 via the order server 2, and communications such as instruction and confirmation are thereby sent.

FIG. 20 shows e-mail type and issue-timing. In this embodiment, e-mails are issued between the user terminal 3, the order manager terminal 5, and the worker terminal 4 via the order server 2. Examples of these e-mails include: the design distribution notice (1) for distributing the design work when the order server 2 receives design orders from the user terminal 3; design work request (2) which the order manager places with the worker based on the design work distribution; the design revision notice (3) for notifying the order manager of revisions to be made to the design created by the worker; design correction request (4) sent by the order manager to the worker for requesting design correction; design completion notice (5) sent to the user from the order manager when the design order is complete; user correction request (6) to the order manager or worker when the user checks the created design and desires design correction; user confirmation notice (7) sent when the user check the created design and does not desire design correction.

E-mail titles are created for these e-mails at the order server 2, and the e-mails are issued. The e-mail title includes progress management information; order number; user name; and work completion time.

Examples of the progress management information include: [design distribution notice], [design work request], [design revision notice], [design correction request], [design completion notice], [user correction request] and [user confirmation notice], and viewing when they are displayed on the e-mail manager screen is facilitated if the e-mails have the same number of characters.

The order number may, for example, be [dc000oi021112002].

The user name may, for example, be [Konica Taro] or [Konica Jiro], thus using the full name of the user.

The work completion time may, for example, be [2002/11/18 05:46:11] or [2002/11/12 16:51:19].

FIG. 21 shows the e-mail issuing screens and the e-mail manager screens for the user terminal, order manager terminal and the worker terminal. It is to be noted generally available e-mail software may be used for the e-mail manager screen.

In this embodiment, the user, the order manager and the worker log in to the order server 2 at the user terminal 3, the order manager terminal 5, and the worker terminal 4 respectively, and e-mails are created at the order server 2, and the necessary instruction, confirmation etc. e-mails are sent to the user, order manager and worker as necessary.

The order manager terminal 5 has a mail issuing screen 85, the worker terminal 4 has a mail issuing screen 86, and the user terminal 3 had a mail issuing screen 87, and at each of these screens, the e-mail address and e-mail title are input, and the e-mail is issued. The e-mail title is such that specified progress management information, order number, user name, work completion time are entered in the specified fields “[ ]-[ ]-[ ]-[ ]”

In addition, the order manager terminal 5 has an e-mail manager screen 80. As shown in FIG. 19, this e-mail manager screen 80 displays the e-mail send time 80a, the sender 80b, and the e-mail title 80c.

At the e-mail manager screen 80, design distribution notice (1), design revision notice (3), user correction request (6), and user confirmation notice (7) are displayed. The e-mail title 80c for the design distribution notice (1) may for example be [design distribution notice]-[dc000oi021112002]-[Konica Taro]-[2002/11/18 05:46:11]”, and is thus in the order of progress management information, order number, user name, and work completion time.

The e-mail title 80c for the design revision notice (3) may for example be [design revision notice]-[dc000oi02112002]-[Konica Taro]-[2002/11/18 05:46:11]”, and is thus in the order of progress management information, order number, user name, and work completion time.

The e-mail title 80c for user correction request (6) may for example be [user correction request]-[dc000oi021112002]-[Konica Taro]-[2002/11/18 05:46:11]”, and is thus in the order of progress management information, order number, user name, and work completion time.

The e-mail title 80c for user confirmation notice (7) may for example be [user confirmation notice]-[dc000oi021112002]-[Konica Taro]-[2002/11/18 05:46:11]”, and is thus in the order of progress management information, order number, user name, and work completion time.

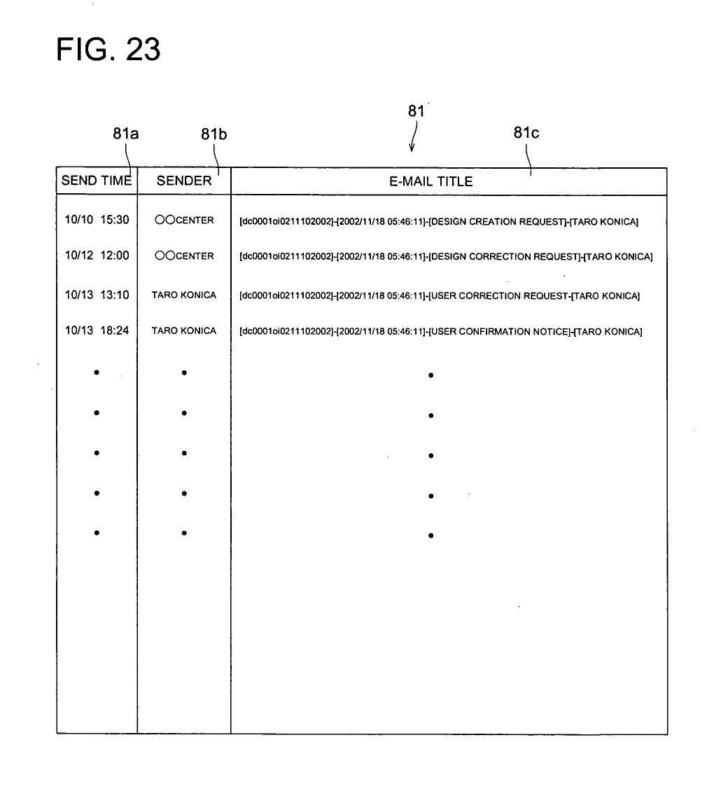

The worker terminal 4 has an e-mail manager screen 81. As shown in FIG. 23, this e-mail manager screen 81 displays the e-mail send time 81a, the sender 81b, and the e-mail title 81c.

At the e-mail manager screen 81, design work request (2), design correction request (4), user correction request (6), and user confirmation notice (7) are displayed.

The e-mail title 81c for the design work request (2) may for example be “[dc000oi021112002]-[2002/11/18 05:46:11]-[design work request]-[Konica Taro]”, and is thus in the order of order number, work completion time, progress management information, and user name.

The e-mail title 81c for the design correction request (4) may for example be “[dc000oi021112002]-[2002/11/18 05:46:11]-[design correction request]-[Konica Taro]”, and is thus in the order of order number, work completion time, progress management information, and user name.

The e-mail title 81c for the user correction request (6) may for example be “[dc000oi021112002]-[2002/11/18 05:46:11]-[user correction request]-[Konica Taro]”, and is thus in the order of order number, work completion time, progress management information, and user name.

The e-mail title 81c for user confirmation notice (7) may for example be “[dc000oi021112002]-[2002/11/18 05:46:11]-[user confirmation notice]-[Konica Taro]”, and is thus in the order of order number, work completion time, progress management information, and user name.

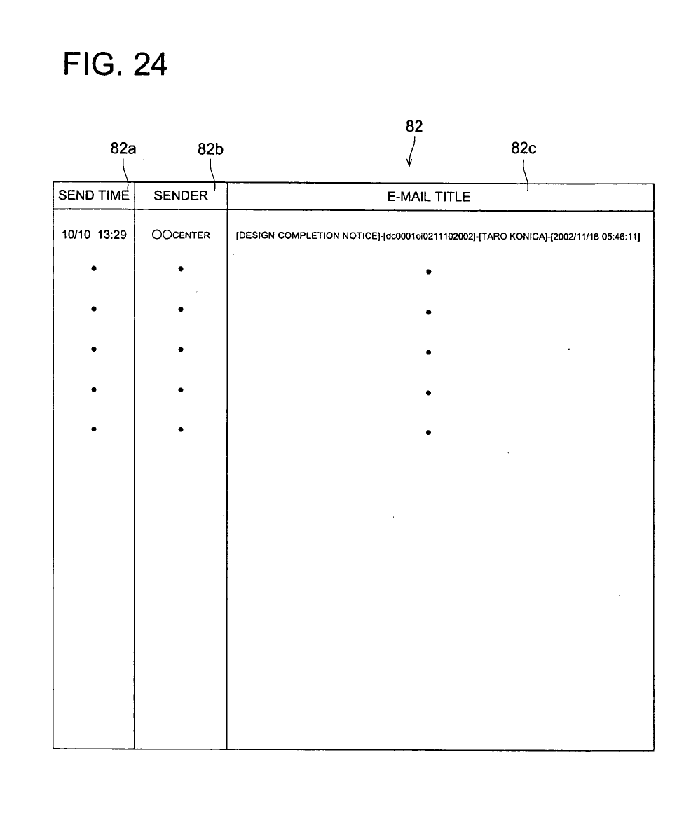

The user terminal 3 has an e-mail manager screen 82. As shown in FIG. 24, this e-mail manager screen 82 displays the e-mail send time 82a, the sender 82b, and the e-mail title 82c.

The design completion notice (5) is displayed at the e-mail manager screen 82. The e-mail title 82c for design completion notice (5) may for example be “[design completion notice]-[dc000oi021112002]-[Konica Taro]-[2002/11/18 05:46:11]”, and is thus in the order of progress management information, order number, user name and work completion time.

In this manner, e-mails are issued between the user terminal 3, the order manager terminal 5, and the worker terminal 4 via the order server 2, and the e-mail title includes at least the progress management information and the order number, and thus by looking at the e-mail title, the general contents can be determined, and design order management can be easily done based the e-mail title.

Further, by also including the user name and work completion time in the e-mail title, in addition to the progress management information and the order number, the general content can be better determined from looking at the e-mail title. Schedule management of work completion time can be ensured by adding a clock function to the order server 2.

At the e-mail management screen 82 of the user terminal 3, and the e-mail management screen 80 of the order manager terminal 5, by displaying the e-mail title with the progress management information at the beginning, the user or order manager can easily determine the progress state from the progress management information display.

Also, at the e-mail management screen 81 of the worker terminal 4, by displaying the e-mail title with the order number at the beginning, the worker can easily determine the progress state from the progress management information display.

In this embodiment, when the order manager issues e-mail from the order manager terminal 5, if it is being sent to the worker terminal 4, it is sent with the order number at the beginning of the e-mail title. For example, the e-mail title may be “[dc000oi021112002]-[2002/11/18 05:46:11]-[design correction request]-[Konica Taro]”, and this e-mail title is displayed at the e-mail manager screen 81 of the worker terminal 4. In this manner, when the e-mail is issued to the worker terminal 4, by sending the e-mail title. For example the e-mail title may be displayed as “[dc000oi021112002]-[2002/11/18 05:46:11] [design revision notice] [Konica Taro]” at the e-mail manager screen 81 of the worker terminal 4. When the e-mail is issued to the worker terminal 4, because the order number is at the beginning of the e-mail title, the worker who receives this e-mail can easily determine the progress state from the order number, and order management at the worker side is simplified.

When the worker issues e-mail from the worker terminal 4, if it is being sent to order manager terminal 5, it is sent with the progress management information at the beginning of the e-mail title. For example, the e-mail title may be “[design revision notice]-[dc000oi021112002]-[Konica Taro]-[2002/11/18 05:46:11]”, and this e-mail title is displayed at the e-mail manager screen 80 of the order manager terminal 5. In this manner, when the e-mail is issued to the order manager terminal 5, by placing the progress management information at the beginning of the e-mail title, the order manager who receives this e-mail can easily determine the progress state from the progress management information, and order management at the order manager side is facilitated.

When the order manager issues e-mail from the order manager terminal 5, if it is being sent to the user terminal 3, it is sent with the progress management information at the beginning of the e-mail title. For example, the e-mail title may be “[design completion notice]-[dc000oi021112002]-[Konica Taro]-[2002/11/18 05:46:11]”, and this e-mail title is displayed at the e-mail manager screen 82 of the order manager terminal 3. In this manner, when the e-mail is issued to the user terminal 3, by placing the progress management information at the beginning of the e-mail title, the user who receives this e-mail can easily determine the progress state from the progress management information, and management at the user side is simplified.

In addition, as shown in FIG. 21 the-mail issuing screen of the order manager terminal 5 has a selection button 85, and by operation the selection button 85, honorific expressions such as “sama” and “onchu”. Can be selected and added. By including these honorific expressions for addressing, the e-mail title will leave a favorable impression on the user.

If the user terminal 3 is, for example, a personal digital assistant (PDA) or mobile phone, the progress management information may be a symbol, and particularly for a portable terminal with limited display area capacity, the symbol can be the e-mail title.

At the user terminal 3, the order manager terminal 5, and the worker terminal 4, when the reply Re: [* * * * ] is received for an e-mail issued as [* * * * ], an alert e-mail may be sent to the issuing terminal so that only e-mails with the set format can be received, and e-mail title management can be done.

At the user terminal 3, the order manager terminal 5, and the worker terminal 4, if there is a file attached to a reply e-mail for an issued e-mail, an alert e-mail may be sent to the sender terminal so that in the same manner, only e-mails with the set format can be received, and e-mail title management can be done.

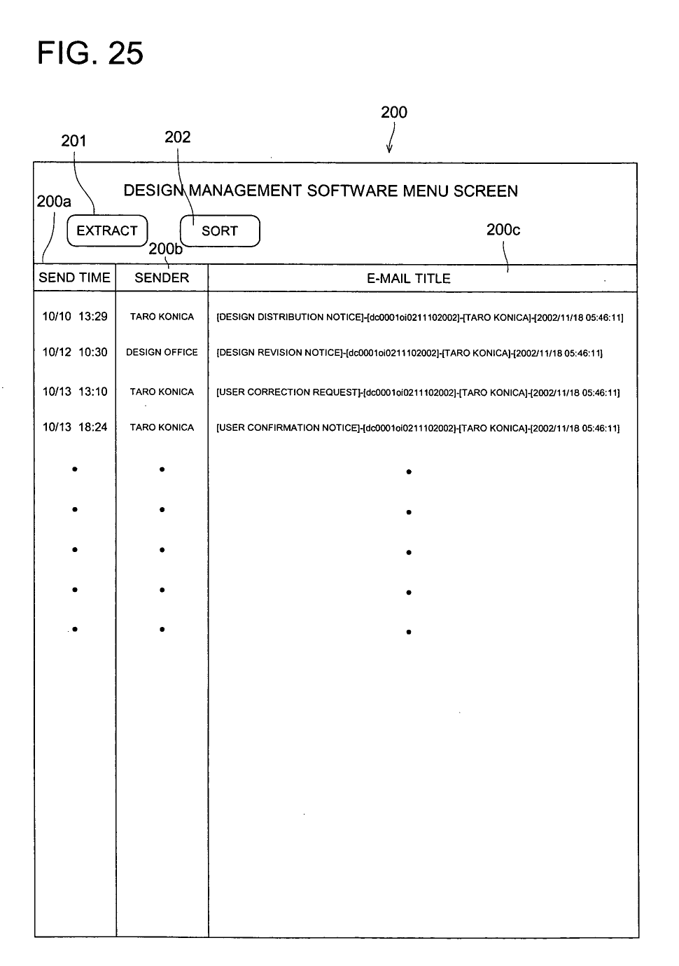

In this embodiment, the order manager distributes the design orders among the workers such as designers, and thus places orders, and when the design creation work is complete, the order manager checks to see whether the design creation matches the order, and at times instruction may be given to correct the design creation work, or work may backs up at the worker side, and there is a large amount of order stock and demands are made for the orders. Thus, as shown in FIG. 25, the order manager terminal 5 has a design management software menu screen 200.

The design management software menu screen 200 displays the e-mail send time 200a, the sender 200b, and the e-mail title 200c. The e-mail title 200c may include progress management information, order number and work completion time as order progress information.

The design management software menu screen 200 has an extract button 201 and a sort button 202.

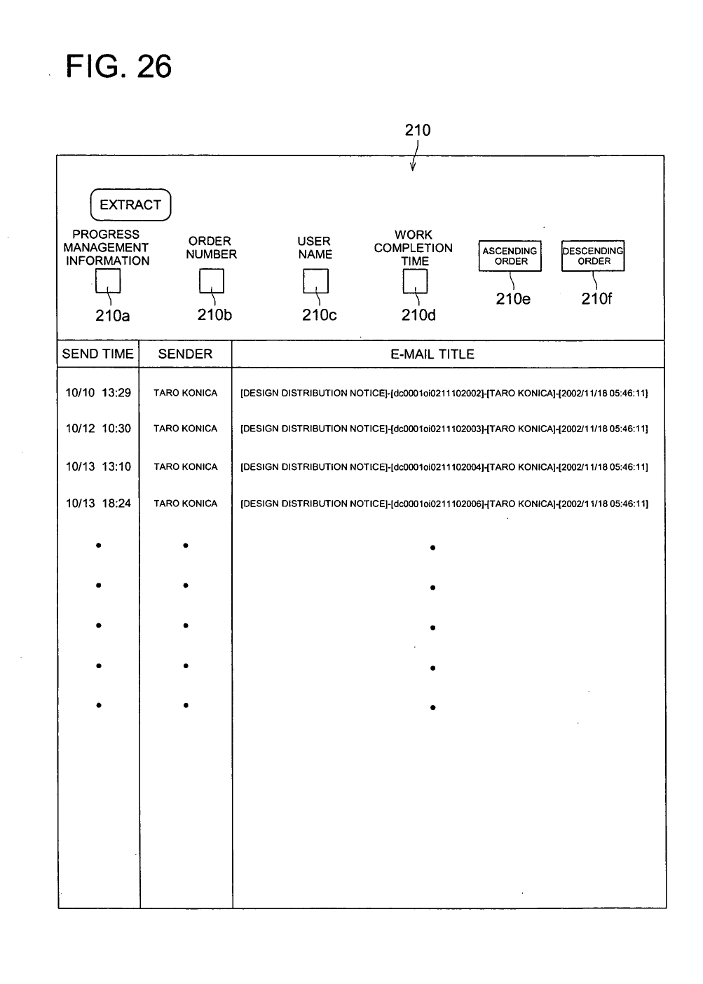

When the extract button 201 is clicked, the extract screen shown 210 shown in FIG. 26 is displayed. The extract screen 210 has a progress management information button 210a, an order number button 210b, a user name button 210c, a work completion time button 210d, an ascending order button 210e, and a descending order button 210f. If the progress management information button 210a is clicked, for example, the e-mail title is displayed with the progress management information at the head of e-mail title. If the order number button 210b is clicked, the e-mail title is displayed with the order number at the head of e-mail title. If the user name button 210c is clicked, the e-mail title is displayed with the user name at the head of e-mail title. If the work completion time button 210d is clicked, the e-mail title is displayed with the work completion time at the head of e-mail title.

Examples of the progress management information include: [design distribution notice], [design work request], [design revision notice] [design correction request], [design completion notice], [user correction request] and [user confirmation notice], for displaying each type of information, and by clicking the ascending order button 210e or the descending order button 210f, the display changes.

In this manner, e-mails are issued between the user terminal 3, the order manager terminal 5, and the worker terminal 4 via the order server 2, and by including the order progress information in the e-mail title of the e-mails and extracting the e-mail title by the order progress information, order management based on e-mail title can be facilitated.

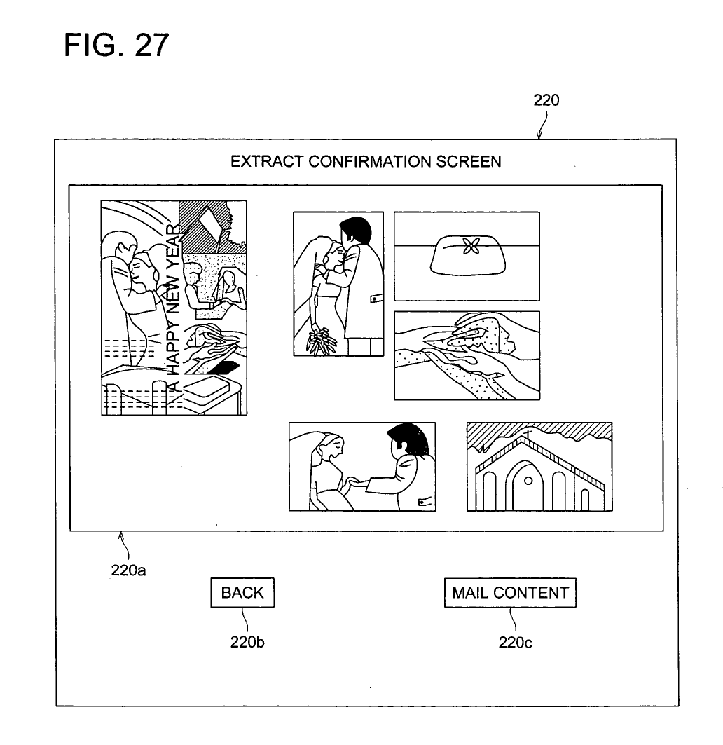

By clicking the e-mail title which has been extracted at the extract screen 210 in FIG. 26, the screen indicated by the e-mail title can be displayed. For example, when the e-mail title for the design distribution notice which has been extracted the extract screen 210 is clicked, the extraction confirmation screen 220 shown in FIG. 27 is displayed. The extract confirmation screen 220 displays the order screen 220a and has a return button 220b and a mail content button 220c. By clicking the-mail content button 220c, the screen that displays the e-mail contents is opened and content of the title design work can be easily determined and processing done.

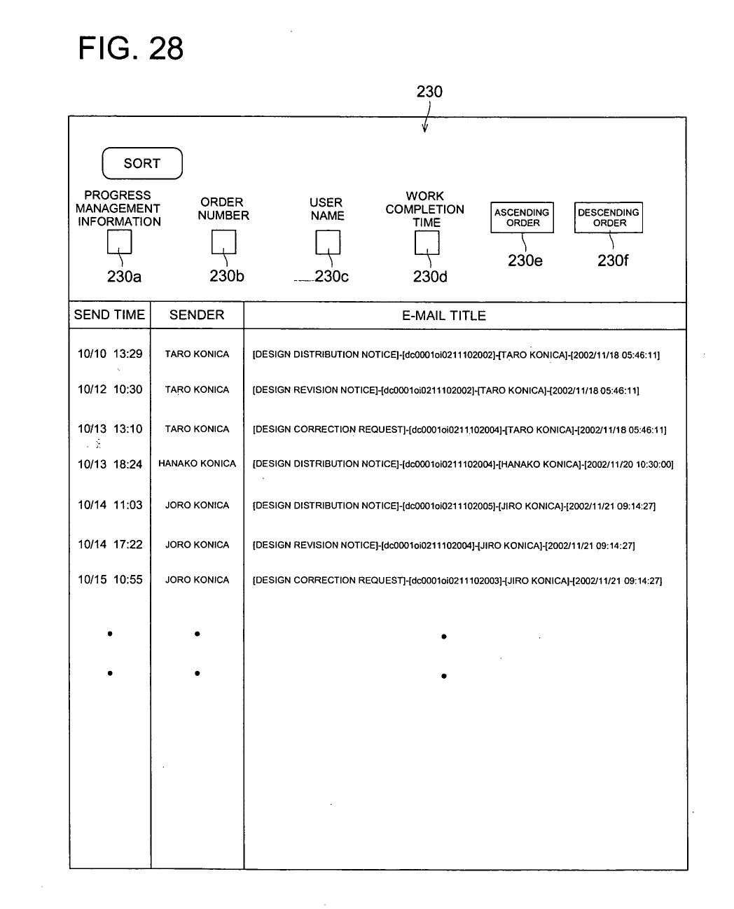

When the sort button 202 of the design management software menu screen 200 is clicked, the sort screen 230 in FIG. 28 is displayed. The sort screen 230 has a progress management information button 230a, an order number button 230b, a user name button 230c, a work completion time button 230d, an ascending order button 230e, and a descending order button 230f. For example, if the progress management information button 230a is clicked, the e-mail titles are sorted by order of progress and displayed with the progress management information at the head of e-mail title. If the order number button 210b is clicked, the e-mail titles are sorted by order number and displayed with the progress management information at the beginning of the e-mail title. If the user name button 210c is clicked, the e-mail titles are sorted in Japanese alphabetical order with the progress management information at the head of the e-mail title. If the work completion time button 210d is clicked, the e-mail titles are sorted by e-mail title in order of work completion time and displayed with progress management information at the head.

Examples of the progress management information include: [design distribution notice], [design work request], [design revision notice], [design correction request], [design completion notice], [user correction request] and [user confirmation notice], and these are displayed for each type of information, and by clicking the ascending order button 230e or the descending order button 230f, the display changes.

In this manner, e-mails are issued between the user terminal 3, the order manager terminal 5, and the worker terminal 4 via the order server 2, and by including the order progress information in the e-mail title of the e-mail and sorting the e-mail titles by order progress information, design order management based on e-mail title can be done easily.

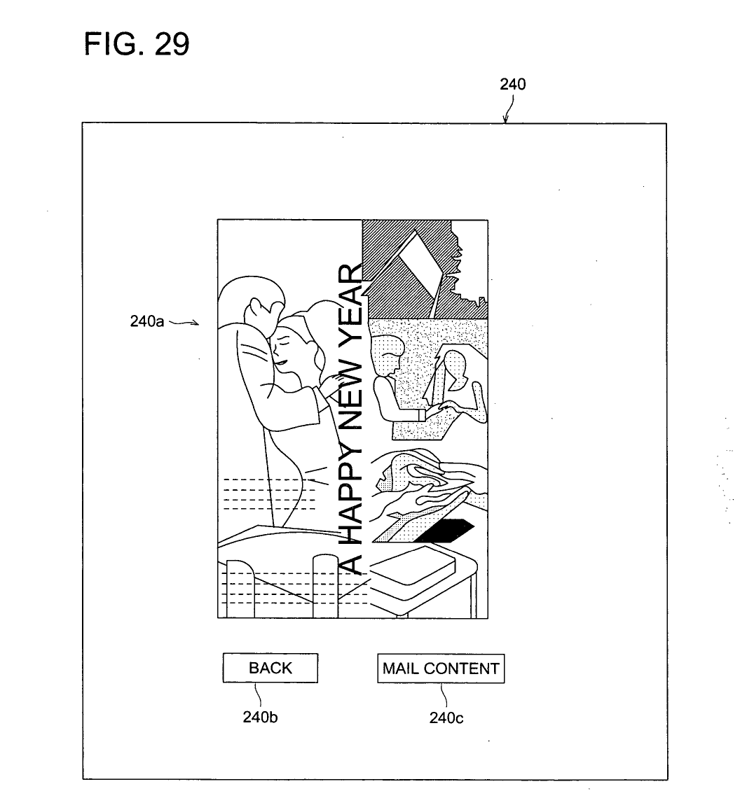

By clicking the e-mail title which has been sorted at the sort screen 230 in FIG. 28, the screens indicated by the e-mail title can be displayed. For example, when the e-mail title for the design revision notice which has been sorted at the extract screen 230 is clicked, the sort confirmation screen 240 shown in FIG. 29 is displayed.

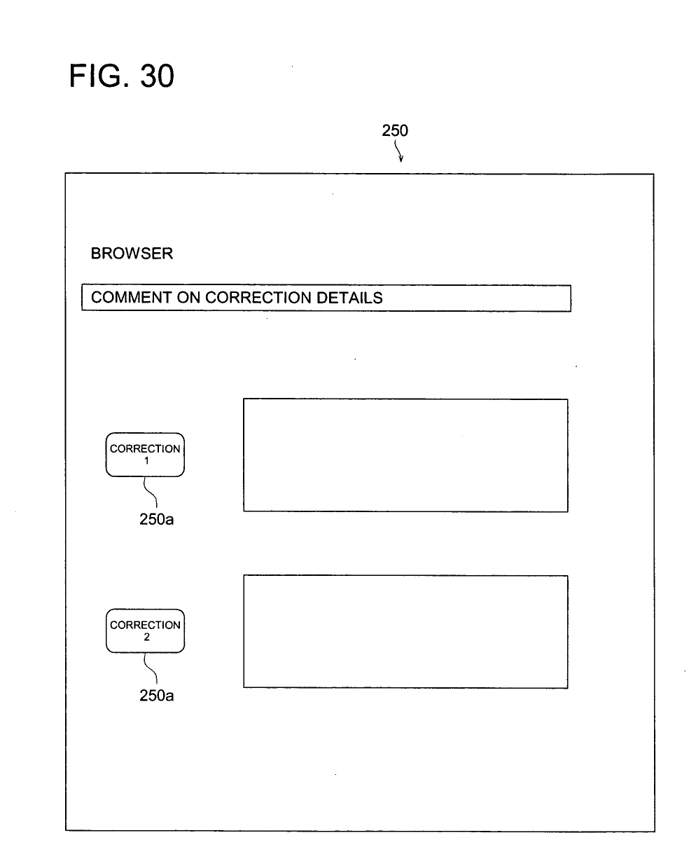

The sort confirmation screen 240 has a correction screen 240a, a return button 240b and a mail content button 240c. By clicking the mail content button 240c, the correction details comment screen 250 shown in FIG. 30, which shows the e-mail content is opened. By clicking the correction button 25a at the correction details comment screen 250, the design correction details can be easily determined and thus the processing can be done.

In the inventions described in (1) and (8) above: from the user terminal, design determining information is input, images for use in the design are uploaded and the design is ordered; at the order manager terminal, design orders are received, ordering of design creation work based on the design orders and order management is done via the order server, and the images for use in the design are displayable, and by displaying the images for use in the design, the status of the images for use in the design can be previewed at the same time that design order is received, and appropriate determinations, such as the man-hour required for completion for the design creation work can be made, and thus the user (customer) can be provided with accurate cost estimates. Also, by simultaneously viewing the images for use in the design and the order instructions for image processing and the like, the desire of the user (customer) can be understood. In addition, it is possible to check if the finished design created by the designer or the like matches the design order of the user (customer), and further checks can be done to determine the state of the photo images for use in the design, and to prevent the occurrence of problems related to rights of portrait and public decency.

In the inventions described in (2) and (9) above, by displaying the images for use in the design, as a list of thumbnail images, a number of images can be viewed and checked simultaneously.

In the inventions described in (3) and (10) above, by displaying the images for use in the design as original images, the state of the image can be more accurately checked, and inspection can be done to prevent occurrence of problems related to rights of portrait and public decency.

In the inventions described in (4) and (11) above, by simultaneously displaying the images for use in the design and the design determining information, design order instruction such as image processing instructions can be viewed simultaneously, and thus the desire of the user (customer) can be more accurately understood.

In the inventions described in (5) and (12) above, the images for use in the design can be inspected, and thus it is possible to check the state of the images and do inspections to prevent occurrence of problems related to rights of portrait and public decency.

In the inventions described in (6) and (13) above, identification marks can be put on the images for use in the design to prevent design image errors.

In the inventions described in (7) and (14) above, by revising the created design, text errors are prevented and thus design quality may be improved.

In the inventions described in (15) and (26) above, by having a design distribution screen for distributing the design orders among the workers, the order can be placed with an ideal worker even if there is a large number of design orders.

In the inventions described in (16) and (27) above, by displaying the work status of each of the workers carrying out the design creation work, the order manger can check the work status for each of the design workers, and thus the order can be easily and quickly placed with a worker that can do the design creation work even if there is a large number of orders.

In the inventions described in (17) and (28) above, by displaying the skill of each of the workers carrying out the design creation work, the order manger can check the skill of each of the design workers, and thus the order can be easily placed with a worker capable of doing the design order content, even if there is a large number of orders.

In the inventions described in (18) and (29) above, by determining skill based on at least one of: correction frequency of created design; average turnaround time for design completion; frequency of late design delivery; design evaluation; and content of user questionnaire, and the order manger can check the skill of each of the design workers, and thus an order can be easily placed with a worker capable of handling the design order content, even if there is a large number of orders.

In the inventions described in (19) and (30) above, because there is a user questionnaire screen, the order manager can consider the opinions of the user in checking the skill of the design workers, and thus an order can be easily placed with a worker capable of handling the design order content.

In the inventions described in (20) and (31) above, because there is a list display screen which displays work status and skill details, work status and skill details can be checked on the same screen, and thus an order can be easily placed with a worker capable of handling the design order content, even if there is a large number of orders.

In the inventions described in (21) and (32) above, by displaying an alert when the frequency of created design correction; the average turnover time for design completion; frequency of late design delivery exceeds a standard, an order can easily be placed with an ideal worker.

In the inventions described in (22) and (33) above, by distributing the design orders among the workers in accordance with the work status of each worker, the order manager can place a design order with an ideal worker without knowing the work status of each of the design workers.

In the inventions described in (23) and (34) above, by distributing the design orders among the workers in accordance with the skill of the worker, the order manager can place a design order with an ideal worker without knowing the skill of each of the design workers.

In the inventions described in (24) and (35) above, by distributing the design orders among the workers based on the work status and the skill of the worker, the order manager can place a design order with an ideal worker without knowing the work status and skill of each of the design workers.

In the inventions described in (25) and (36) above, by distributing the design orders among the workers based on the type of design order and/or level of difficulty of the design, each of the design orders can be placed with an ideal worker.

In the inventions described in (37) and (50) above, e-mails are issued between the user terminal, the order manager terminal and the worker terminal via the order server, and by including at least progress management information and an order number in the title of the issued e-mails, the general contents of the e-mail can be determined by looking at the e-mail title, and the design orders can be easily managed based on the e-mail title.

In the inventions described in (38) and (51) above, by including the user name and the work completion time in addition to the progress management information and the order number in the e-mail title, the general contents of the e-mail can be better determined from looking at the e-mail title, and the orders can be easily managed based on the e-mail title.

In the inventions described in (39) and (52) above, by making it impossible to manipulate the work completion time, the work completion time can be safely used. By using the order server clock, consistency is achieved, while if more than one clocks is used there will be time inconsistencies.

In the inventions described in (40) and (53) above, by displaying the e-mail title at the e-mail manager screen with the progress management information at the beginning, the order manager can easily determine the progress state from the progress management information display.

In the inventions described in (41) and (54) above, by displaying the e-mail title at the e-mail manager screen with the order number at the beginning, the worker can easily determine the progress state from the order number display.

In the inventions described in (42) and (55) above, by displaying the e-mail title at the e-mail manager screen with the progress management information at the beginning, the user can easily determine the progress state from the progress management information display.

In the inventions described in (43) and (56) above, when the e-mail is issued, it the destination is the worker terminal, by sending the e-mail with the order number at the beginning of the e-mail title, the worker who receives the e-mail can easily determine the progress state from the order number, and thus order management at the worker side is facilitated.

In the inventions described in (44) and (57) above, when the e-mail is issued, if the destination is the order manager terminal, by sending the e-mail with the progress management information at the beginning of the e-mail title, the order manager who receives the e-mail can easily determine the progress state from the progress management information, and thus order management at the order manager side is facilitated.

In the inventions described in (45) and (58) above, when the e-mail is issued, if the destination is the user terminal, by sending the e-mail with the progress management information at the beginning of the e-mail title, the user who receives the e-mail can easily determine the progress state from the progress management information display, and this facilitates management at the user side.

In the inventions described in (46) and (59) above, for e-mails being sent to the user terminal, by including honorific terms for addressing in the e-mail title, the e-mail title will have favorable impression on the user.

In the inventions described in (47) and (60) above, because the progress management information is a symbol, this symbol can be the e-mail title particularly for mobile phones with limited capacity for the display area.

In the inventions described in (48) and (61) above, when a reply to an issued e-mail is received, by sending a notifying e-mail to the issuing terminal, only e-mail having a set format can be received, and thus e-mail title management can be done.

In the inventions described in (49) and (62) above, when there is a file attached to the reply to an issued e-mail, by sending a alert e-mail to the issuing terminal, only e-mail having a set format can be received, and thus e-mail title management can be done.

In the inventions described in (63) and (69) above, e-mails are issued between the user terminal, order manager terminal and the worker terminal via the order server, and by including the order progress information in the title of the issued e-mails and extracting the e-mail title by the order progress information, design order management based on e-mail title can be done easily based on e-mail title.

In the inventions described in (64) and (70) above, by including by including progress management information, order number and user name in the order progress information, design order management based on e-mail title can be done more easily.

In the inventions described in (65) and (71) above, because by clicking the extracted e-mail, the screen that corresponds to the e-mail title is displayed, the progress state of the design creation work, e-mail content and the like can be determined, and thus processing can be done.

In the inventions described in (66) and (72) above, e-mails are issued between the user terminal, order manager terminal and the worker terminal via the order server, and by including the order progress information in the title of the issued e-mails and sorting the e-mail titles by the order progress information, design order management based on e-mail title can be done easily.

In the inventions described in (67) and (73) above, by including progress management information, order number and user name in the order progress information, design order management based on-e-mail title can be done more easily.

In the inventions described in (68) and (74) above, because by clicking the sorted e-mail title, the screen that corresponds to the e-mail title is displayed, the progress state of the design creation work, e-mail content and the like can be determined, and thus processing can be done.

What is claim;

1. An order-receiving system comprising:
a user terminal connected to a network, and comprising;
an inputting device to input design determining information,
an uploading device to upload images for use in a design,
a user ordering device to order the design, an order manager terminal connected to the network, and comprising;
a receiving device to receive the design orders from the user ordering device,
a manager ordering device to order for the design creation work based on the design order,
a managing device to manage the design creation work,
a displaying device to display to the images for use in the design, and
a worker terminal connected to the network, and comprising;
a creating device to create designs based on the orders placed for the design creation work.

2. The order-receiving system of claim 1, wherein at the order manager terminal, the images for use in the design can be displayed as a list of thumbnail images.

3. The order-receiving system of claim 1, wherein at the order manager terminal, the images for use in the design can be displayed as original images.

4. The order-receiving system of claim 1, wherein at the order manager terminal, the images for use in the design and the design determining information can be displayed simultaneously.

5. The order-receiving system of claim 1, wherein at the order manager terminal, the images for use in the design can be inspected.

6. The order-receiving system of claim 1, wherein at the order manager terminal, identification marks can be attached to the images for use in the design.

7. The order-receiving system of claim 1, wherein at the order manager terminal, the created design can be revised.

8. The order-receiving system of claim 1, wherein at the order manager terminal has a design distribution screens for distributing the design orders among the workers.

9. The order-receiving system of claim 8, wherein the design distribution screens displays the work status of each of the workers carrying out the design creation work.

10. The order-receiving system of claim 8, wherein the design distribution screens displays the skills of each of the workers carrying out the design creation work.

11. The order-receiving system of claim 8, wherein the skill is determined based on at least one of: correction frequency for created design; average turnaround time for design completion; frequency of late design delivery; design evaluation; and content of user questionnaire.

12. The order-receiving system of claim 8, wherein the user terminal has a user questionnaire screen.

13. The order-receiving system of claim 8, wherein the order manager terminal has a list display screen that displays work status and skill details.

14. The order-receiving system of claim 13, wherein the list display screen displays an alert when correction frequency for created design; average turnover time for design completion; or frequency of late design delivery exceeds a standard.

15. The order-receiving system of claim 8, wherein the order manager terminal distributes the design orders among the workers in accordance with the work status of each of the workers.

16. The order-receiving system of claim 8, wherein the order manager terminal distributes the design orders among the workers in accordance with the skill of each of the workers.

17. The order-receiving system of claim 8, wherein the order manager terminal distributes the design orders among the workers in accordance with the work status and the skill of each of the workers.

18. The order-receiving system of claim 8, wherein the order manager terminal distributes the design orders among the workers in accordance with the type of design order and/or level of difficulty of the design order.

19. The order-receiving system of claim 1, further comprising:
an issuing device to issue e-mails between the user terminal, the order manager terminal and the worker terminal via the order server, wherein the title of the e-mails issued include at least progress management information and an order number.

20. The order-receiving system of claim 19, wherein the e-mail title includes user name and work completion time, in addition to progress management information and order number.

21. The order-receiving system of claim 20, wherein the work completion time is generated by the clock function of the order server.

22. The order-receiving system of claim 19, wherein at the e-mail manager screen of the order manager terminal, the e-mail title is displayed with the progress management information at the beginning.

23. The order-receiving system of 19, wherein at the e-mail manager screen of the worker terminal, the e-mail title is displayed with the order number at the beginning.

24. The order-receiving system of claim 19, wherein at the e-mail manager screen of the user terminal, the e-mail title is displayed with the progress management information at the beginning.

25. The order-receiving system of claim 19, wherein, when the e-mail is issued, if the destination is the worker terminal, the e-mail is sent with the order number at the beginning of the e-mail title.

26. The order-receiving system of claim 19, wherein, when the e-mail is issued, if the destination is the order manager terminal, the e-mail is sent with the progress management information at the beginning of the e-mail title.

27. The order-receiving system of claim 19, wherein, when the e-mail is issued, if the destination is the user terminal, the e-mail is sent with the progress management information at the beginning of the e-mail title.

28. The order-receiving system of claim 19, wherein honorific terms for addressing are included in e-mail title being sent to the user terminal.

29. The order-receiving system of claim 19, wherein the progress management information is a symbol.

30. The order-receiving system of claim 19, wherein when a reply to the issued e-mail is received, an alert e-mail is sent to the issuing terminal.

31. The order-receiving system of claim 19, wherein when there is a file attached to the reply to the issued e-mail, an alert e-mail is sent to the issuing terminal.

32. The order-receiving system of claim 1, further comprising:
an issuing device to issue e-mails between the user terminal, the order manager terminal and the worker terminal via the order server, wherein order progress information is included in the title of the issued e-mails and the e-mail titles are extracted by the order progress information.

33. The order-receiving system of claim 32, wherein the order progress information includes the progress management information, the order number and the user name.

34. The order-receiving system of claim 32, wherein by clicking the extracted e-mail, the screen that corresponds to the e-mail title is displayed.

35. The order-receiving system of claim 32, wherein the e-mail title is sorted by the order progress information.

36. The order-receiving system of claim 35, wherein the order progress information includes the progress management information, the order number and the user name.

37. The order-receiving system of claim 35, wherein by clicking the sorted e-mail, the screen that corresponds to the e-mail title is displayed.

38. An order-receiving method comprising steps of:
inputting design determining information to a user terminal that connected to a network,
uploading images for use in the design,
ordering the design from a user terminal;
receiving the design orders by an order manager terminal that connected to the network,
placing orders for the design creation work based on the design orders,
managing the design creation work based on the design orders,
displaying the image for use in the design at an order manager terminal that connected to the network, and
creating the design based on the order placed for the design creation work at a worker terminal.

39. The order-receiving method of claim 38, wherein the images for use in the design can be displayed as a list of thumbnail images.

40. The order-receiving method of claim 38, wherein the images for use in the design can be displayed as original images.

41. The order-receiving method of claim 38, wherein the images for use in design and the design determining information can be displayed simultaneously.

42. The order-receiving method of claim 38, wherein the images for use in the design can be inspected.

43. The order-receiving method of claim 38, wherein identification marks can be attached to the images for use in the design.

44. The order-receiving method of claim 38, wherein the created design is revised.

45. The order-receiving method of claim 38, further comprising step of:
distributing the design orders at the order manager terminal, and
displaying the distribution of design orders among the workers.

46. The order-receiving method of claim 45, wherein the work status for each of the workers who carry out the design creation work is displayed.

47. The order-receiving method of claim 45, wherein the skill of each of the workers who carry out the design creation work is displayed.

48. The order-receiving method of claim 45, wherein the skill is determined based on at least one of: correction frequency of created design; average turnaround time for design completion; frequency of late design delivery; design evaluation; and content of user questionnaire.

49. The order-receiving method of claim 45, wherein the user answers a questionnaire at the user questionnaire screen of user terminal.

50. The order-receiving method of claim 45, wherein the descriptions of work status and skill are displayed on the list display screen of the order manager terminal.

51. The order-receiving method of claim 50, wherein an alert is displayed at the list display screen when correction frequency of created design; average turnaround time for design completion; or frequency of late design delivery exceeds a standard.

52. The order-receiving method of claim 45, wherein the design orders are distributed among the workers in accordance with the work status of each of the workers.

53. The order-receiving method of claim 45, wherein the design orders are distributed among the workers in accordance with the skill of each of the workers.

54. The order-receiving method of claim 45, wherein the design orders are distributed among the workers in accordance with the work status and the skill of each of the workers.

55. The order-receiving method of claim 45, wherein the design orders are distributed among the workers in accordance with the type of design order and/or level of difficulty of the design order.

56. The order-receiving method of claim 38, further comprising step of:
issuing e-mail between the user terminal, the order manager terminal and the worker terminal via the order server, and the title of the issued e-mails include at least progress management information and order number.

57. The order-receiving method of claim 56, wherein the e-mail title includes the user name and the work completion time, in addition to the progress management information and the order number.

58. The order-receiving method of claim 57, wherein the work completion time is generated by the clock function of the order server.

59. The order-receiving method of claim 56, wherein at the e-mail manager screen of the order manager terminal, the e-mail title is displayed with the progress management information at the beginning.

60. The order-receiving method of claim 56, wherein at the e-mail manager screen of the worker terminal, the e-mail title is displayed with the order number at the beginning.

61. The order-receiving method of claim 56, wherein at the e-mail manager screen of the user terminal, the e-mail title is displayed with the progress management information at the beginning.

62. The order-receiving method of claim 56, wherein when the e-mail is issued, if the destination is the worker terminal, the e-mail is sent with the order number at the beginning of the e-mail title.

63. The order-receiving method of claim 56, wherein when the e-mail is issued, if the destination is the order manager terminal, the e-mail is sent with the progress management information at the beginning of the e-mail title.

64. The order-receiving method of claim 56, wherein when the e-mail is issued, if the destination is the user terminal, the e-mail is sent with the progress management information at the beginning of the e-mail title.

65. The order-receiving method of claim 56, wherein honorific address terms are included in e-mail title being sent to the user terminal

66. The order-receiving method of claim 56, wherein the progress management information is a symbol.

67. The order-receiving method of claim 56, wherein when a reply to the issued e-mail is received, an alert e-mail is sent to the issuing terminal.

68. The order-receiving method of claim 56, wherein when there is file attached to the reply to the issued e-mail, an alert e-mail is sent to the issuing terminal.

69. The order-receiving method of claim 38, further comprising step of:
issuing e-mails between the user terminal, the order manager terminal and the worker terminal via the order server, wherein order progress information is included in the title of the issued e-mails and the e-mail titles are extracted by the order progress information.

70. The order-receiving method of claim 69, wherein the order progress information includes the progress management information, the order number and the user name.

71. The order-receiving method of claim 69, wherein by clicking the extracted e-mail, the screen that corresponds to the e-mail title is displayed.

72. The order-receiving method of claim 38, wherein the title of the e-mails issued include the order progress information, and the e-mail titles are sorted by order progress information.

73. The order-receiving method of claim 72, wherein the order progress information includes the progress management information, the order number and the user name.

74. The order-receiving method of claim 72, wherein by clicking the sorted e-mail, the screen that corresponds to the e-mail title is displayed.
